(19) United States
(12) Patent Application Publication
(10) Pub. No.: US 2006/0053677 A1
(43) Pub. Date: Mar. 16, 2006

(54) Fishing rod holder support stanchion member for holding multiple fishing rod holders in combination with a flush mounted rod holder

(76) Inventor: George Legendziewicz, Flemington, NJ (US)

Correspondence Address: Ezra Sutton, Esq.;Suite 201, 900 Route 9, Plaza 9 Building, Woodbridge, NJ, 07095, US

(21) Appl. No.: 11/191,294

(22) Filed: Sep. 23, 2005

Related U.S. Application Data
(63) Continuation of application No. 10/714,160, filed on Nov. 13, 2003.

(51) Int. Cl. A01K 97/10

(52) U.S. Cl. 43/21.2

(57) ABSTRACT

A fishing rod holder assembly for holding one or more fishing rods thereto. The fishing rod holder assembly includes a flush mounted rod holder mounted within a gunwale of a boat; a fishing rod holder for holding a fishing rod thereto; and a fishing rod holder support stanchion member having an anchoring post with a horizontal crossbar member connected thereto. The horizontal crossbar member includes a first opposing end and a second opposing end; the first opposing end having a first vertical holding post connected thereto and the second opposing end having a second vertical holding post connected thereto for forming a goalpost configuration thereof. The anchoring post is adaptably mounted within the flush mounted rod holder; and at least one of the fishing rod holders is detachably mounted on the first vertical holding post of the fishing rod holder support stanchion member and another one of the fishing rod holders is detachably mounted on the vertical holding post of the fishing rod holder support stanchion member for forming a fishing rod holder assembly thereof.

### FIELD OF THE INVENTION

The present invention relates to a fishing rod holder assembly for holding multiple fishing rod holders being mounted to a fishing rod holder support stanchion member in combination with a flush mounted rod holder. More particularly, the fishing rod holder assembly further includes a rotatable, movable and re-positionable fishing rod holder being mounted to a fishing rod holder support stanchion member in combination with a flush mounted rod holder within a gunwale of a boat

### BACKGROUND OF THE INVENTION

Sport fishing comes in various formats, for example, a lure or bait is repeatedly cast into the water and retrieved. In those situations, the person doing the fishing must hold the fishing rod at all times. However, in many other fishing forms, it is not necessary or desirable for the fisherman to hold onto the fishing rod at all times. In this fishing format, the bait or lure is cast into the water, either from the shore or from a boat, and is then allowed to remain in the water until a fish strikes. Since the bait is not being constantly cast and retrieved, there is no need for the fisherman to hold the fishing rod until a fish strikes the bait.

Similarly, another common fishing format is to “troll” for fish, by trailing a line from a fishing rod behind a slowly moving boat, with a bait or lure attached to the end of the line. This allows a wide area of water to be covered, without the need to constantly cast and retrieve the bait. Once a fish is hooked, the boat is stopped and the fish is played to the boat in a normal manner. Again, until a fish is hooked, there is no need for the fisherman to hold the fishing rod in his or her hands. Indeed, in trolling the movement of the bait and the line through the water causes significant dragging forces, which can make holding the fishing rod for extended periods difficult and tiring. Moreover, if each fishing rod is held, fisherman can only handle a single rod. This limits the number of lines that can be trolled behind the boat, decreasing the chances of hooking a fish.

More particularly, saltwater sport fishing typically consists of placing anglers on boats to reach productive offshore fishing grounds. Sport fishing targets popular saltwater species including bluefish, striped bass, dolphin, tuna, blue and black marlin, sailfish, shark, grouper, wahoo, and tarpon. A productive method of catching a fish involves a technique known as trolling wherein the angler drags baited hooks or lures behind the stern of a slow moving boat. Trolling is the favored method for saltwater big-game fishing which generally requires a boat and equipment capable of withstanding heavy seas and large fish. To increase the chance of hooking a fish, it is an important consideration to have as many lines in the water as possible. With a multitude of baited lines, the fisherman can strategically simulate bands of straggling or displaced fish from the school. These stragglers are the weaker fish that gamefish typically prey upon.

Thus, the fisherman would ideally like to drag as many lines as possible behind the boat to increase the chances of a strike. However, the more lines that are used, the more the chance of the lines becoming tangled with each other. This is particularly true of a narrow beam boat or when the boat is being turned. As a result, sport fishing outriggers have been developed to assist in keeping the various lines separated.

An outrigger consists of a long boom, or pole, which is attached to the boat in various manners and is deployed to extend laterally outwards from the boat. Baited fishing lines, with release clips, are attached to the outriggers and thereby provide enough separation between the lines to prevent tangling. When a fish strikes the bait, the line clip releases from the outrigger and the fisherman reels in the fish.

In trolling operations, it is common to cause the boat to drag the lure or bait at substantial distances, i.e. 20 to 150 feet, behind the boat over a suspected location of fish and if a fish is caught, then to turn the boat and again drag the lure or bait past the same location. Such turning of the boat often can be rather sharp and even when the fisherman is attending a single rod, close attention must be paid to not entangling a fishing line with the boat or motor during the turn. Such possible entanglement is increased when there are multiple lines extending from the rear of the boat. Such multiple lines introduce the further potential problem of entanglement of the several lines with one another during the turn. In the prior art it has been common to attach individual rod holders to the gunwale of the boat so that the rods and their associated lines would be as spaced apart as far as possible with the intent to minimize line entanglement.

When using gunwale mounted rod holders on a boat with limited gunwale space, one may be able to mount only one rod on each side of the boat, thereby limiting the fisherman to the use of two rods during trolling. Still further, gunwale mounted rod holders are located a maximum distance from the fisherman thereby requiring substantial movement within the boat in attending the rods with resultant danger of falls within the boat or more seriously falling overboard. Such movements are especially dangerous when multiple fish are caught simultaneously, as frequently happens when trolling, and the fisherman is hurrying to reel them in.

Through the years, a variety of approaches have been used to hold a fishing rod in place while waiting for a fish to strike the bait, to allow hands-free fishing, and to allow a single fisherman to manage several rods at once. Thus, outrigger devices have been developed for use on boats. For instance, on sport fishing boats, individual tubes have been mounted onto the rails of boats, or onto chairs. Again, the base end of a fishing rod is inserted into the tube, which supports the rod in a desired position until a fish is hooked.

Other non-tubular outrigger devices have been developed that are mounted onto the deck or rail of a boat or other platform, and are adapted to receive the handle end of a fishing rod. Each device holds a single fishing rod, at a single orientation.

Despite these efforts to provide suitable rod holders, the existing prior art devices are limited in many respects. Most notably, the prior art has not provided a simple unitary rod holder assembly that is capable of holding a plurality of fishing rods in place at a single time. Nor has the prior art provided a rod holder for holding multiple rods that can be mounted onto a boat or other rigid platform, while allowing the direction and inclination of each rod to be independently varied according to the needs of a particular situation. Finally, the prior art has not provided a device that is easily assembled and disassembled, and is strong enough to withstand the forces that are exerted when trolling with multiple rods.

Additionally, by law (and practicality), outriggers must be freely stowable to a folded position along side the boat for close water operation and docking. For practical operation, the outrigger must necessarily be swung laterally outward to its deployed position. The prior art, not necessarily patented, but used for many years in the field, includes all types of mounting schemes including outrigger units for horizontal and vertical mounting, on center consoles, flybridges, half towers, tuna towers, radar arches, and/or T-tops. Prior patents disclose a variety of methods for mounting, deploying, and locking into place such outriggers with each having distinct drawbacks. Such drawbacks include overall mechanical complexity; powered operation; non-durable metal-on-metal construction; and/or ineffective position adjustment and locking mechanisms which slip and/or wear out, especially due to metal-on-metal construction.

There remains a need for a fishing rod holder assembly having a fishing rod holder support stanchion member for holding a plurality of fishing rod holders in combination with a flush mounted rod holder within a gunwale of a boat. Additionally, there is a need for an improved and novel movable and re-positionable fishing rod holder being mounted to the fishing rod holder support stanchion member in combination with the flush mounted rod holder within the gunwale of a boat.

### DESCRIPTION OF PRIOR ART PATENTS

U.S. Pat. No. 3,802,112 to BANNER discloses a fishing rod holding means pivotally connected to a base part having means of securing same to different surfaces. The angle of the holding means is adjusted to a desired position and held by locking means. A fishing pole locking means is provided separately within the holder means, said holder means also having a fishing hook holding means. This prior art patent does not teach or disclose the particular structure and configuration of the present invention of a fishing rod holder support stanchion member for holding a plurality of fishing rod holders in combination with a flush mounted rod holder within a gunwale of a boat.

U.S. Pat. No. 3,964,706 to ADAMS discloses a holder assembly for fishing rods and fishing accessories. The holder assembly for use with one or more fishing rods or the like, including a number of readily replaceable elements adapted to hold any standard fishing rod during actual fishing, as in trolling, and safely store the rod while cruising to and from the fishing grounds, the assembly comprising a mounting base with keyhole connecting means for quickly attaching to or detaching from a supporting surface, a tubular socket on the base, an elongated sleeve for slidably receiving and holding a fishing rod handle, and means for readily securing and detaching the sleeve to and from the socket. The substitution of another sleeve having a portion with a larger diameter enables the holding of larger and heavier fishing rods. The substitution of another mounting base having a different angular arrangement of the tubular socket renders the holder assembly readily mountable on verticals, horizontal or angled supporting surfaces of a boat and permits the changing of the angular position of the held fishing rod. This prior art patent does not teach or disclose the particular structure and configuration of the present invention of a fishing rod holder support stanchion member for holding a plurality of fishing rod holders in combination with a flush mounted rod holder within a gunwale of a boat.

U.S. Pat. No. 4,527,349 to EMORY, Jr. discloses a trolling bar assembly having an elongated member or board which defines a plurality of longitudinally spaced rod holder apertures, a plurality of tubular rod holders and a pair of support brackets for securing the elongated member to the boat. The tubular rod holders are retained in the apertures of the elongated bar by a pair of longitudinally spaced garter springs disposed in notches formed in the tubular holders. The support brackets are adjustable longitudinally of the bar. This prior art patent does not teach or disclose the particular structure and configuration of the present invention of a fishing rod holder support stanchion member for holding a plurality of fishing rod holders in combination with a flush mounted rod holder within a gunwale of a boat.

U.S. Pat. No. 4,823,723 to BROOKS discloses a trolling rig for fishing boats. The trolling rig is used for removably mounting a plurality of fishing rods on the deck of fishing boat centrally of the aft end thereof, such rig comprising a plurality of rod holders mounted on the outboard end of an upright shaft that is received in a mounting bracket on the deck, each rod holder receiving the butt end of a rod such that the rod extends upwardly and outwardly with respect to the upright shaft, at least one rod being disposed on the starboard side of the boat and one rod being disposed on the port side of the boat. Optionally a third rod holder is provided for positioning a rod above an in alignment with the centerline of the boat and extending upwardly and outwardly above the boat motor. This prior art patent does not teach or disclose the particular structure and configuration of the present invention of a fishing rod holder support stanchion member for holding a plurality of fishing rod holders in combination with a flush mounted rod holder within a gunwale of a boat.

U.S. Pat. No. 4,901,469 to MURRAY discloses an expansible frame for mounting downriggers on a fishing boat. The expansible device is attachable to the stern of a boat for mounting fishing rigs such as downriggers thereon. The device includes a framework which extends horizontally across the stern of the boat, with a pair of expansible members disposed near the outboard edges of the framework. The expansible members include extensions telescopically received in the framework which move from a retracted position to an extended, outboard position by means of linear actuators to provide an extended mounting area. This prior art patent does not teach or disclose the particular structure and configuration of the present invention of a fishing rod holder support stanchion member for holding a plurality of fishing rod holders in combination with a flush mounted rod holder within a gunwale of a boat.

U.S. Pat. No. 5,735,093 to MINORICS, et al. discloses a fishing jig device for jigging a multiplicity of fishing pole rods. The device includes a stanchion and a horizontal support member rotatably mounted to the stanchion. A multiplicity of rod holders for holding fishing rods radially extends from the support member. These rod holders have dimensions adequate to receive and support a fishing rod. The rod holders are jigged via a handle or a foot pedal which is operatively connected to the support member. To prevent the support member from over-rotating and spilling the fishing rods, stops are provided on the support member and the stanchion. The fishing jig device can be secured to a boat or land using a variety of mechanisms such as clamps, pegs, spikes or a stand. This prior art patent does not teach or disclose the particular structure and configuration of the present invention of a fishing rod holder support stanchion member for holding a plurality of fishing rod holders in combination with a flush mounted rod holder within a gunwale of a boat.

U.S. Pat. No. 5,438,789 to EMORY discloses a fishing rod holder assembly having a channel, a bracket, a hub and a rod holder. The channel may be mounted on the boat at any angle desired, from horizontal to vertical. The bracket is configured to be slidably inserted within the channel in any of four orientations. The hub, which is rotatably mounted on the bracket, defines a plurality of apertures. A pin is positioned on the bracket. A spring biases the hub against the bracket to a positive, locked position with the pin in one of the apertures. Separate tile pieces, configured to be slidably inserted within the channel, space rod holders on the channel. This prior art patent does not teach or disclose the particular structure and configuration of the present invention of a fishing rod holder support stanchion member for holding a plurality of fishing rod holders in combination with a flush mounted rod holder within a gunwale of a boat.

U.S. Pat. No. 5,557,877 to COLSON discloses a universal mount fishing rod holder for holding a plurality of fishing rods in a position for use when fishing. The fishing rod holder includes a rigid planar base coupled to a tubular receptacle; a coupling mechanism for securing the base to an external recipient object; a rigid planar bar positioned above the base; an elongated support rod having one end removably coupled within the receptacle of the base and another end pivotally coupled to the bar; and a plurality of spaced and parallely aligned rod holders with each rod holder formed of an elongated rigid piece of wire having an anterior section with a generally v-shaped seat for holding a portion of a fishing rod, a posterior section with a loop for receiving an end of a fishing rod, and a central section extended therebetween and coupled to the bar. This prior art patent does not teach or disclose the particular structure and configuration of the present invention of a fishing rod holder support stanchion member for holding a plurality of fishing rod holders in combination with a flush mounted rod holder within a gunwale of a boat.

U.S. Pat. No. 5,054,737 to DELANCEY discloses a universal support apparatus for a fishing rod that includes a base adapted for mounting on a vertical or horizontal surface, a fishing rod receptacle, and an articulated support member having opposing ends connected to the base and receptacle for movement of the receptacle about three perpendicular axes. This prior art patent does not teach or disclose the particular structure and configuration of the present invention of a movable and re-positionable fishing rod holder being mounted to a fishing rod holder support stanchion member in combination with a flush mounted rod holder within a gunwale of a boat.

U.S. Pat. No. 5,685,107 to SWEET discloses a fishing rod holder which is capable of simultaneously supporting a plurality of fishing rods during fishing operations. The fishing rod holder includes a base plate for mounting the fishing rod holder onto a boat or other platform, a central support that extends upward from the base plate, a crossmember attached to the central support and extending outward from the central support, and a plurality of fishing rod cradles spaced at intervals along the crossmember. Each fishing rod cradle supports an individual fishing rod oriented in a desired direction, at a desired inclination. This prior art patent does not teach or disclose the particular structure and configuration of the present invention of a fishing rod holder support stanchion member for holding a plurality of fishing rod holders in combination with a flush mounted rod holder within a gunwale of a boat.

U.S. Pat. No. 5,855,088 to LEE discloses an outrigger pivot assembly structured to rotatably support an outrigger fishing assembly having a shaft bottom end, the pivot assembly including a support housing coupled to a support surface of a boat and structured to generally receive and support a positioning member therein. The positioning member, which is coupled with the shaft bottom end of the outrigger fishing assembly, is structured to rotate the outrigger fishing assembly upon rotation thereof relative to the support housing. An outrigger pivot assembly further includes a handle assembly structured to rotate the positioning member and outrigger fishing assembly upon pivoted movement thereof about a perimeter of the support housing, and a lock assembly having a channel with at least a first position, a second position and a connection segment wherethrough the handle assembly is structured to selectively move when not being retained in place as a result of a structure of said lock assembly. This prior art patent does not teach or disclose the particular structure and configuration of the present invention of a rotatable, movable and re-positionable fishing rod holder being mounted to a fishing rod holder support stanchion member in combination with a flush mounted rod holder within a gunwale of a boat.

U.S. Pat. No. 5,921,014 to LEE discloses an outrigger lowering assembly structured to pivot a fishing pole between a generally lowered and a generally elevated orientation, the assembly including an outrigger engagement hub having a retention segment which receives a fishing pole butt end of the fishing pole securely therein, and a pivot segment supportingly extending from the retention segment into pivoted, supported engagement with a base assembly that is secured to the boat. The pivot segment pivots relative to the base assembly so as to vary an elevation orientation of said outrigger engagement hub between a first and a second elevation positions, and the base assembly includes a first and a second housing portions movably coupled with one another between a locked orientation and a disengaged orientation, wherein the locked orientation maintains a pin in a corresponding lock position of a channel, and the disengaged orientation moves the pin out of the lock position so as to permit pivoted movement of the outrigger engagement hub into another elevation orientation. Upon reaching the new elevation orientation, a restraining assembly urges the pin into a corresponding lock position so as to maintain the desired orientation of the outrigger engagement hub, and accordingly, the fishing pole. This prior art patent does not teach or disclose the particular structure and configuration of the present invention of a movable and re-positionable fishing rod holder being mounted to a fishing rod holder support stanchion member in combination with a flush mounted rod holder within a gunwale of a boat.

U.S. Pat. No. 6,213,441 to BAYNARD, et al. discloses a fishing rod holder mount including a base unit which an be secured or affixed to a supporting surface such as the upper rail or gunwale of a boat; a shaft which is received by the base unit and therefore secured to the supporting surface; and an interlocking mechanism between the base and shaft which prevents the shaft and therefore the fishing rod holder from rotating about the shaft axis. The fishing rods held by the fishing rod holder are prevented from rotating across the boat or supporting surface. Therefore, the fishing rod is prevented from striking a boat occupant, tangling with other rods or objects, and prevented from complicating reeling in of a fish. This prior art patent does not teach or disclose the particular structure and configuration of the present invention of a fishing rod holder support stanchion member for holding a plurality of fishing rod holders in combination with a flush mounted rod holder within a gunwale of a boat.

U.S. Pat. No. 6,289,627 to GIBBS et al. discloses a folding stowable trolling rig for removably mounting a plurality of fishing rods in desired, operable positions above the deck of a boat, such rig mounting atop a standard fishing seat pedestal of the type found on bass boats and requiring no tools or special hardware for installation. The trolling rig includes a plurality of longitudinally spaced rod holders pivotally mounted to a pair of folding support arms, one end of each being pivotally attached to either side of a central mounting base, the underside of which having a post that inserts into the seat mounting socket atop the fishing seat pedestal. Automatic alignment of each rod holder, both in folded and opened positions, is controlled by a pair of alignment bars pivotally mounted to the holders and to either side of the mounting base just above and parallel to the support arms. The rod holders and the support arms all fold together into compact alignment for transporting or stowing the trolling rig. This prior art patent does not teach or disclose the particular structure and configuration of the present invention of a fishing rod holder support stanchion member for holding a plurality of fishing rod holders in combination with a flush mounted rod holder within a gunwale of a boat.

U.S. Pat. No. 6,302,367 to RATZA, et al. discloses a fishing rod holder including a cradle shaped to receive and selectively retain a fishing rod therein, and includes a first ratchet half thereon. A support pedestal that has a mount for attaching the fishing rod holder to a support surface, and includes a second ratchet half shaped to selectively lockingly engage with the first ratchet half. A quick-release connector mechanism permits angular adjustment between the cradle and the support pedestal. The quick-release connector mechanism includes an actuator pin extending centrally between the first and second ratchet halves, and rotatably connecting the cradle and the support to permit mutual rotation between a variety of different cradle positions. The actuator pin has a fixed end associated with one of the cradle and the spark pedestal, and a free end associated with the other of the cradle and support pedestal. The quick-release connector mechanism has an actuator lever pivotally operably connected with the free end of the actuator pin, and a cam configured to selectively engage the other of the cradle and the support pedestal when rotated to a locked position, wherein the first and second ratchet halves are converged to retain the cradle at a pre-selected position relative to the support pedestal. The actuator lever is shiftable to an unlocked position wherein the first and second ratchet halves are separated, such that the cradle may be rotated relative to the support pedestal. This prior art patent does not teach or disclose the particular structure and configuration of the present invention of a movable and re-positionable fishing rod holder being mounted to a fishing rod holder support stanchion member in combination with a flush mounted rod holder within a gunwale of a boat.

U.S. Publication No. 2001/0011435 A1 to BAYNARD, et al. discloses a dual position fishing rod holder for supporting a fishing rod in a plurality of fishing positions wherein the rod holder includes a front fork support having a pair of arms between which the fishing rod is held and a plurality of rod retention elements spaced from the front support fork which position and retain the fishing rod in different elevations and fishing positions. This prior art patent does not teach or disclose the particular structure and configuration of the present invention of a fishing rod holder support stanchion member for holding a plurality of fishing rod holders in combination with a flush mounted rod holder within a gunwale of a boat.

None of the aforementioned patents and publications disclose or teach the structure, design and configuration of the present invention of the fishing rod holder assembly that includes a fishing rod holder support stanchion member for holding a plurality of fishing rod holders in combination with a flush mounted rod holder within a gunwale of a boat. Additionally, none of the aforementioned prior art references disclose or teach the particular design, configuration or structure of a movable and re-positionable fishing rod holder being mounted to a fishing rod holder support stanchion member in combination with a flush mounted rod holder within a gunwale of a boat.

Accordingly, an object of the present invention is to provide a fishing rod holder assembly for holding multiple fishing rods that allows power boats, such as pleasure cruisers, small fishing boats, having limited gunwale space for fishing or trolling to fish, troll or hold two or more fishing rods being received within using two or more mountable fishing rod holders.

Another object of the present invention is to provide a fishing rod holder assembly that includes a fishing rod holder support stanchion member, a plurality of fishing rod holders, and a flush mounted rod holder for use on pleasure fishing boats or small commercial fishing boats.

Another object of the present invention is to provide for a fishing rod holder support stanchion member that includes two or more vertical holding posts being integrally attached to a crossbar member and the crossbar member integrally attached to the anchoring post.

Another object of the present invention is to provide for a fishing rod holder assembly that allows the ability to fish/troll/hold more fishing poles than would be possible using the existing rod holders mounted on a boat (gunwale flush mount or clamp-on type).

Another object of the present invention is to provide a fishing rod holder support stanchion member for holding a plurality of fishing rod holders in combination with a flush mounted rod holder within a gunwale of a boat.

Another object of-the present invention is to provide the ability to fish/troll/hold a plurality of fishing rods by attaching commercially available vertical mounted fishing rod holders to the rod holder support stanchion member of the fishing rod holder assembly which is anchored to a flush mounted rod holder in the gunwale of a boat.

Another object of the present invention is to provide a fishing rod holder support stanchion member having two or more vertical holding posts that show a goalpost configuration, a Y-shaped configuration, a U-shaped configuration, and a skewed angled configuration.

Another object of the present invention is to provide a fishing rod holder support stanchion member that includes a plurality of vertical holding posts integrally attached to a telescoping crossbar member.

Another object of the present invention is to provide a fishing rod holder support stanchion member that allows a longer extension of one side of the crossbar member to extend outside of the gunwale of the boat in order to maximize the separation of the outside fishing rod from the inside fishing rod.

Another object of the present invention is to provide a fishing rod holder assembly that has integrally attached fishing rod holders to each of the vertical holding posts of fish rod holders support stanchion member providing a “ready to use” assembly.

Another object of the present invention is to provide a fishing rod holder support stanchion member having a crossbar member being rotatable relative to the anchoring post using an adjustable locking block member.

Another object of the present invention is to provide a fishing rod holder assembly that incorporates a locking block for the crossbar member and anchoring post allowing unlimited angle adjustment of the vertical holding posts relative to the attached fishing rod holders.

Another object of the present invention is to provide a fishing rod holder support stanchion member having one or more vertical posts that are independently rotatable relative to each other using the adjustable locking block member.

Another object of the present invention is to provide a single fishing rod holder assembly that can be adapted to fit any of the commercially available 15+, 30° or 90° flush mount rod holders.

Another object of the present invention is to provide a fishing rod holder assembly having a pair of independently L-shaped rotatable holder support stanchion members that move relative to each other using an adjustable locking block.

Another object of the present invention is to provide for a fishing rod holder assembly in which the joint between the crossbar member and vertical holding post can be rotated 360° relative to a stationary crossbar member.

Another object of the present invention is to provide a fishing rod holder assembly that has permanently mounted, fully adjustable fishing rod holders that can be rotated 360° around, and up and down on the vertical holding posts of the fishing rod holder support stanchion member.

Another object of the present invention is to provide a fishing rod holder support stanchion member having vertical posts with each having a removably attached fishing rod holder that is adjustable to a predetermined angle.

Another object of the present invention is to provide a fishing rod holder support stanchion member having multiple interior holding compartments for forming a multiple angle fishing rod holder member for the angled positioning of a fishing rod therein.

Another object of the present invention is to provide a fishing rod holder support stanchion member having vertical posts that are angled and movable in a 120° arc.

Another object of the present invention is to provide a fishing rod holder support stanchion member being constructed to form a single integral unit by means of welding an/or tubular bending.

Another object of the present invention is to provide a fishing rod holder support stanchion member that is made of lightweight and easy to clean metals such as aluminum, stainless steel, titanium and other steel alloys.

Another object of the present invention is to provide a fishing rod holder assembly that is easy to assemble having a minimum amount of moving parts, easy to use and maintain for any type of boat.

A further object of the present invention is to provide a fishing rod holder assembly that can be mass-produced in an automated and economical manner and is readily affordable by the user.

### SUMMARY OF THE INVENTION

In accordance with the preferred embodiment of the present invention, there is provided a fishing rod holder assembly for holding one or more fishing rod thereto. The fishing rod holder assembly includes a flush mounted rod holder mounted within a gunwale of a boat; a fishing rod holder for holding a fishing rod thereto; and a fishing rod holder support stanchion member having an anchoring post with a horizontal crossbar member connected thereto. The horizontal crossbar member includes a first opposing end and a second opposing end; the first opposing end having a first vertical holding post connected thereto and the second opposing end having a second vertical holding post connected thereto for forming a goalpost configuration thereof. The anchoring post is adaptably mounted within the flush mounted rod holder; and at least one of the fishing rod holders is detachably mounted on the first vertical holding post of the fishing rod holder support stanchion member and another one of the fishing rod holders is detachably mounted on the vertical holding post of the fishing rod holder support stanchion member for forming a fishing rod holder assembly thereof.

An alternate embodiment of the present invention is also provided to include a fishing rod holder assembly for holding one or more fishing rods thereto. The fishing rod holder assembly includes a flush mounted rod holder mounted within a gunwale of a boat; a fishing rod holder for holding a fishing rod therein; and a modified fishing rod holder support stanchion member having an anchoring post having a pair of angled vertical holding posts connected at a distal end of the anchoring post of the modified fishing rod holder support stanchion member for forming a Y-shaped configuration. The anchoring post being adaptably mounted within the flush mounted rod holder; and at least one of the fishing rod holders is detachably mounted on one of the angled vertical holding posts of the modified fishing rod holder support stanchion member and another one of the fishing rod holders is detachably mounted to the other one of the angled vertical holding posts of the modified fishing rod holder support stanchion member for forming a fishing rod holder assembly thereof.

Another alternate embodiment of the present invention is additionally provided to include a fishing rod holder assembly for holding one or more fishing rod thereto. The fishing rod holder assembly includes a flush mounted rod holder mounted within a gunwale of a boat; a fishing rod holder for holding a fishing rod therein; and a fishing rod holder support stanchion member having an anchoring post having a horizontal crossbar member connected thereto. The horizontal crossbar member having a first opposing end and a second opposing end; and the first opposing end having a first vertical holding post connected thereto and the second opposing end having a second vertical holding post connected thereto for forming a goalpost configuration thereof. The anchoring post is adaptably mounted within the flush mounted rod holder; and the fishing rod holder includes a connecting arm for permanently attaching to each of the first and second vertical holding posts of the fishing rod holder support stanchion member for forming a fishing rod holder assembly thereof.

In still another alternate embodiment of the present invention is also provided to include a fishing rod holder assembly for holding one or more fishing rods thereto. The fishing rod holder assembly includes a flush mounted rod holder mounted within a gunwale of a boat; a fishing rod holder for holding a fishing rod therein; and a rotatable fishing rod holder support stanchion member having a U-shaped holding post member with a horizontal crossbar member with first and second opposing ends. Each of the first and second opposing ends includes a connected first and second vertical holding post, respectively, thereon. The horizontal crossbar member includes a centrally located crossbar splined section being circumferentially machined on an outer wall surface of the horizontal crossbar member of the U-shaped holding post member. The rotatable fishing rod holder support stanchion member further includes an adjustable locking block member having an upper locking block section and a lower locking block section with a bottom wall surface.

The upper and lower locking block sections of the adjustable locking block member are used to detachably and rotatably engage the centrally located crossbar splined section. Further, the upper and lower locking block sections of the adjustable locking block member are joined together by attaching means for connecting and forming the upper and lower locking block sections around the centrally located crossbar splined sections. The rotatable fishing rod holder support stanchion member also includes an anchoring post having a proximal end and a distal end thereto. The proximal end of the anchoring post includes a locking notched end for engaging a safety gimbal pin within the flush mounted rod holder; and the distal end of the anchoring post is connected to the bottom wall surface of the lower locking block section of the adjustable locking block member. The joined adjustable locking block member on the U-shaped holding post member and the anchoring post are assembled together to form a goalpost configuration. Additionally, at least one of the fishing rod holders is detachably mounted on the first vertical holding post of the U-shaped holding post member and another one of the fishing rod holders is detachably mounted on the second vertical holding post of the U-shaped holding post member for forming a fishing rod holder assembly thereof.

### BRIEF DESCRIPTION OF THE DRAWINGS

Further objects, features, and advantages of the present invention will become apparent upon the consideration of the following detailed description of the presently preferred embodiment when taken in conjunction with the accompanying drawings, wherein:

FIG. 1 is a perspective view of the fishing rod holder assembly of the preferred embodiment of the present invention showing the fishing rod holder assembly and its component parts thereon in an assembled state and in operation use thereof;

FIG. 2 is an exploded perspective view of the fishing rod holder assembly of the present invention showing each of the fishing rod holders being attached to a vertical holding post and an anchoring post of the support stanchion member being inserted within the flush mounted rod holder on the gunwale of the boat;

FIG. 3 is a perspective view of the fishing rod holder assembly of the present invention showing the fishing rod holder assembly having a pair of fishing rod holders attached to the vertical holding posts of the fishing rod holder support stanchion member and a flush mounted rod holder within a gunwale of a boat;

FIG. 4 is a side elevational view of the fishing rod holder support stanchion member of the preferred embodiment of the present invention showing one of the vertical holding posts integrally attached to a crossbar member and the crossbar member integrally attached to the anchoring post;

FIG. 5 is a top plan view of the fishing rod holder support stanchion member of the preferred embodiment of the present invention showing each of the vertical holding posts integrally attached to the crossbar member;

FIG. 6 is a perspective view of the fishing rod holder support stanchion member of a first alternate configuration of the preferred embodiment of the present invention showing an angled vertical holding post relative to a vertically skewed vertical holding post of the fishing rod holder support stanchion member;

FIG. 7 is a perspective view of the fishing rod holder support stanchion member of a second alternate configuration of the preferred embodiment of the present invention showing a Y-shaped design of the fishing rod holder support stanchion member;

FIG. 8 is a perspective view of the fishing rod holder support stanchion member of a third alternate configuration of the preferred embodiment of the present invention showing a plurality of vertical holding posts integrally attached to the crossbar member to form a trident-shaped goalpost design;

FIG. 9 is a perspective view of the fishing rod holder support stanchion member of a fourth alternate configuration of the preferred embodiment of the present invention showing a plurality of vertical holding posts integrally attached to a telescoping crossbar member to a trident-shaped goalpost design;

FIG. 10 is a perspective view of the fishing rod holder support stanchion member of a second alternate embodiment of the present invention showing an integrally formed U-shaped holding post-crossbar member, an adjustable locking block member having an upper locking block and a lower locking block with an integrally attached anchoring post;

FIG. 11 is an exploded perspective view of the fishing rod holder support stanchion member of the second alternate embodiment of the present invention showing the U-shaped holding post-crossbar member, the upper locking block, and the lower locking block with the integrally attached anchoring post;

FIG. 12 is a side perspective view of the fishing rod holder support stanchion member of the second alternate embodiment of the present invention showing the adjustable locking block member in an assembled state and in an operational mode;

FIG. 13 is a top perspective view of the fishing rod holder support stanchion member of the second alternate embodiment of the present invention showing the adjustable locking block member in an assembled state and in an operational mode;

FIG. 14 is an exploded perspective view of the fishing rod holder support stanchion member of a first alternate configuration of the second alternate embodiment of the present invention showing a pair of L-shaped holding post-crossbar members, the upper locking block and the lower locking block with the integrally attached anchoring post;

FIG. 15 is a perspective view of the fishing rod holder assembly of the third alternate embodiment of the present invention showing each of the fishing rod holders being integrally connected to each of the vertical holding posts of the fishing rod holder support stanchion member;

FIG. 16 is an enlarged perspective view of the fishing rod holder assembly of the third alternate embodiment of the present invention showing an attachment arm to the fishing rod holder integrally connected via welding to the vertical holding post of the fishing rod holder support stanchion member;

FIG. 17 is a perspective view of the fishing rod holder assembly of the fourth alternate embodiment of the present invention showing each of the non-removable adjustable rod holder assemblies being rotatable and angled on each of the vertical holding posts of the fishing rod holder support stanchion member;

FIG. 18 is an exploded perspective view of the fishing rod holder assembly of the fourth alternate embodiment of the present invention showing the adjustable rod holder assembly having a rod holder member, an attachment arm with a movable pin joint flexing arm, an upper movable collar, a middle movable main collar, a lower stationary collar all being movably attached to the vertical holding post;

FIG. 19 is a side elevational view of the fishing rod holder assembly of the fourth alternate embodiment of the present invention showing the adjustable rod holder assembly in an assembled state and in a vertical orientation;

FIG. 20 is a side elevational view of the fishing rod holder assembly of the fourth alternate embodiment of the present invention showing the adjustable rod holder assembly in an assembled state and being rotated and moved to an angled orientation;

FIG. 21 is a perspective view of the fishing rod holder assembly of the fifth alternate embodiment of the present invention showing each of the fixed position rod holders on each of the ratcheted and rotatable vertical holding posts being mounted on a flat crossbar member and the flat crossbar member attached to the anchoring post;

FIG. 22 is a perspective view of the fishing rod holder assembly of the fifth alternate embodiment of the present invention showing the ratcheted and rotatable vertical holding post and the flat crossbar member in an assembled state;

FIG. 23 is a cross-sectional view of the fishing rod holder assembly of the fifth alternate embodiment of the present invention taken along section line 23-23 of FIG. 21 in the direction of the arrows showing the ratcheted and rotatable vertical holding post being attached to the flat crossbar member by the connecting nut and bolt elements;

FIG. 24 is a cross-sectional view of the fishing rod holder assembly of the fifth alternate embodiment of the present invention taken along section line 24-24 of FIG. 21 in the direction of the arrows showing an assembled state of the ratcheted and rotatable vertical holding post attached to the flat crossbar member by the connecting nut and bolt elements;

FIG. 25 is perspective view of the fishing rod holder assembly of the sixth alternate embodiment of the present invention showing a pair of multiple angle fishing rod holder members detachably mounted by ratcheting means on each end of the flat crossbar member being integrally attached to the anchoring post of the fishing rod holder support stanchion member;

FIG. 26 is an exploded perspective view of the multiple angle fishing rod holder assembly of the sixth alternate embodiment of the present invention showing the multiple angle fishing rod holder member integrally attached to an upper ratchet collar and a lower ratchet collar attached to the flat crossbar member;

FIG. 27 is a cross-sectional view of the multiple angle fishing rod holder assembly of the sixth alternate embodiment of the present invention showing each of the interior holding compartments for the angled positioning of a fishing rod therein;

FIG. 28 is a bottom plan view of the multiple angle fishing rod holder assembly of the sixth alternate embodiment of the present invention showing a removable rod holding pin for anchoring a fishing rod, within one of the interior holding compartments of the multiple angle fishing rod holder member;

FIG. 29 is an enlarged bottom plan view of the multiple angle fishing rod holder assembly of the sixth alternate embodiment of the present invention showing the removable rod holding pin for anchoring the fishing rod within the first interior holding compartment of the multiple angle fishing rod holder member;

FIG. 30 is a perspective view of the multiple angle fishing rod holder assembly of the sixth alternate embodiment of the present invention showing the fishing rod being held in a first angled position of a 90° alignment within the first interior holding compartment of the multiple angle fishing rod holder member;

FIG. 31 is a perspective view of the multiple angle fishing rod holder assembly of the sixth alternate embodiment of the present invention showing the fishing rod being held in a second angled position of a 60° alignment within the second interior holding compartment of the multiple angle fishing rod holder member;

FIG. 32 is a perspective view of the multiple angle fishing rod holder assembly of the sixth alternate embodiment of the present invention showing the fishing rod being held in a third angled position of a 45° alignment within the third interior holding compartment of the multiple angle fishing rod holder member;

FIG. 33 is a perspective view of the multiple angle fishing rod holder assembly of the sixth alternate embodiment of the present invention showing the fishing rod being held in a fourth angled position of a 30° alignment within the fourth interior holding compartment of the multiple angle fishing rod holder member;

FIG. 34 is a perspective view of the multiple angle fishing rod holder assembly of the sixth alternate embodiment of the present invention showing the multiple angle fishing rod holder assembly detachably connected to a single anchoring post for inserting within a flush mounted 90° rod holder on the gunwale of a boat;

FIG. 35 is an exploded perspective view of the multiple angle fishing rod holder assembly of the sixth alternate embodiment of the present invention showing a housing member having multiple interior holding compartments within an upper compartment section, a vertical holding stanchion member having an upper ratchet locking collar thereon and a lower ratchet locking collar attached to a single anchoring post thereto;

FIG. 36 is a cross-sectional view of the multiple angle fishing rod holder assembly of the sixth alternate embodiment of the present invention taken along line 36-36 of FIG. 35 in the direction of the arrows showing the ratcheted and rotatable upper ratchet locking collar being readied for attachment to the lower ratchet locking collar of the ratchet locking assembly on the single anchoring post;

FIG. 37 is a perspective view of the multiple angle fishing rod holder assembly of a first alternate configuration of the sixth alternate embodiment of the present invention showing a multiple angle fishing rod holder member detachably connected to a single anchoring post for inserting within a flush mounted angled rod holder on the gunwale of the boat; and

FIG. 38 is a perspective view of the multiple angle fishing rod holder assembly of a second alternate configuration of the sixth alternate embodiment of the present invention showing each of the cylindrical-shaped interior holding compartments for the angled positioning of the multiple angle fishing rod holder for holding of a fishing rod therein.

DESCRIPTION OF THE COMPONENT PARTS

| PART | |
|---|---|
| NO. | COMPONENT PARTS |
| 10 | fishing rod holder assembly |
| 12 | fishing rod(s) |
| 12h | fishing rod handle |
| 12g | gimbaled butt end of rod handle |
| 12n | handle locking notch |
| 14 | fishing boat |
| 16 | gunwale |
| 18 | vertical or horizontal rail |
| 20 | fishing rod holder |
| 22 | rod holder member |
| 24 | outer wall surface |
| 26 | inner wall surface |
| 28 | fishing rod opening |
| 30 | proximal end |
| 32 | distal end |
| 34 | rod holding pin |
| 36 | connecting arm |
| 38 | first end |
| 40 | second end |
| 42 | centrally located position |
| 44 | adjustable holding clamp |
| 46 | first curved clamping section |
| 48 | second curved clamping section |
| 50 | plurality of holding bolts |
| 52a, | first set of clamping tabs |
| 52b | |
| 54a, | second set of clamping tabs |
| 54b | |
| 56 | plurality of countersunk mounting openings |
| 58 | clamp opening |
| 60 | fishing rod holder support stanchion member |
| 62 | anchoring post |
| 64 | proximal end |
| 66 | distal end |
| 68 | locking notched end |
| 70 | horizontal crossbar member |
| 72 | first opposing end |
| 74 | second opposing end |
| 76 | first vertical holding post |
| 78 | second vertical holding post |
| 80 | goalpost configuration |
| 82 | integrally connected singly constructed unit |
| 84 | outer wall surface |
| 90 | flush mounted rod holder |
| 92 | mounting rim |
| 94 | plurality of countersunk mounting openings |
| 96 | mounting bolt/screw |
| 98 | tubular body member |
| 100 | rod holder opening |
| 102 | proximal end |
| 104 | distal end |
| 106 | plastic/rubber sleeve |
| 108 | sleeve opening |
| 110 | safety gimbal pin |

FIRST ALTERNATE CONFIGURATION 200 OF
THE PREFERRED EMBODIMENT

| | |
|---|---|
| 200 | fishing rod holder assembly |
| 220 | fishing rod holder |
| 260 | fishing rod holder support stanchion member |
| 262 | anchoring post |
| 264 | proximal end |
| 266 | distal end |
| 268 | locking notched end |
| 270 | horizontal crossbar member |
| 272 | first opposing end |
| 274 | second opposing end |
| 280S | skewed and angled goalpost configuration |
| 284 | outer wall surface |
| 290 | flush mounted rod holder |
| 292 | mounting rim |
| 397 | skewed first vertical holding post |
| 399 | skewed second vertical holding post |

SECOND ALTERNATE CONFIGURATION 400 OF
THE PREFERRED EMBODIMENT

| | |
|---|---|
| 400 | fishing rod holder assembly |
| 420 | fishing rod holder |
| 460 | fishing rod holder support stanchion member |
| 462 | anchoring post |
| 464 | proximal end |
| 466 | distal end |
| 468 | locking notched end |
| 490 | flush mounted rod holder |
| 526 | first angled vertical holding post |
| 528 | second angled vertical holding post |
| 530 | Y-shaped configuration |

THIRD ALTERNATE CONFIGURATION 600 OF
THE PREFERRED EMBODIMENT

| | |
|---|---|
| 600 | fishing rod holder assembly |
| 620 | fishing rod holder |
| 660 | fishing rod holder support stanchion member |
| 662 | anchoring post |
| 664 | proximal end |
| 666 | distal end |
| 668 | locking notched end |
| 670 | elongated horizontal crossbar member |
| 672 | first opposing end |
| 674 | second opposing end |
| 676 | first vertical holding post |
| 678 | second vertical holding post |
| 690 | flush mounted rod holder |
| 738 | center vertical holding post |
| 740 | trident-shaped goalpost configuration |

FOURTH ALTERNATE CONFIGURATION 800 OF
THE PREFERRED EMBODIMENT

| | |
|---|---|
| 800 | fishing rod holder assembly |
| 820 | fishing rodholder |
| 860 | fishing rod holder support stanchion member |
| 862 | anchoring post |
| 864 | proximal end |
| 866 | distal end |
| 868 | locking notched end |
| 870 | elongated horizontal crossbar member |
| 872 | first opposing end |
| 874 | second opposing end |
| 876 | first vertical holding post |
| 884 | outer wall surface |
| 890 | flush mounted rod holder |
| 938 | center vertical holding post |
| 942 | L-shaped telescoping member |
| 944 | vertical holding post |
| 946 | horizontal crossbar section |
| 948 | crossbar section opening |
| 950 | turn-stop opening |
| 952 | turn-stop member |
| 954 | plurality of turn-stop openings |
| 960 | adjustable trident-shaped goalpost configuration |

SECOND ALTERNATE EMBODIMENT 1000

| | |
|---|---|
| 1000 | fishing rod holder assembly |
| 1020 | fishing rod holder |
| 1022 | rod holder member |
| 1028 | fishing rod opening |
| 1034 | rod holding pin |
| 1036 | connecting arm |
| 1044 | adjustable holding clamp |
| 1058 | clamp opening |
| 1060 | rotatable fishing rod holder support stanchion member |
| 1062 | anchoring post |
| 1064 | proximal end |
| 1066 | distal end |
| 1068 | locking notched end |
| 1080 | goalpost configuration |
| 1090 | flush mounted rod holder |
| 1112 | U-shaped holding post member |
| 1114 | horizontal crossbar member |
| 1116 | first opposing end |
| 1118 | second opposing end |
| 1120 | first vertical holding post |
| 1122 | seocnd vertical holding post |
| 1124 | centrally located crossbar splined section |
| 1126 | outer wall surface |
| 1130 | adjustale locking block member |
| 1132 | upper locking block section |
| 1134 | lower locking block section |
| 1136 | top wall surface of upper locking block section |
| 1138 | upper locking block threaded mounting openings |
| 1140 | mounting bolts |
| 1142 | bottom wall surface of upper locking block section |
| 1144 | upper block splined section |
| 1146 | top wall surface of lower locking block section |
| 1148 | lower locking block threaded mounting openings |
| 1150 | lower block splined section |
| 1152 | bottom wall surface of lower locking block section |

FIRST ALTERNATE CONFIGURATION 1200 OF
THE SECOND ALTERNATE EMBODIMENT

| | |
|---|---|
| 1200 | fishing rod holder assembly |
| 1220 | fishing rod holder |
| 1222 | rod holder member |
| 1228 | fishing rod opening |
| 1234 | rod holding pin |
| 1236 | connecting arm |
| 1244 | adjustable holding clamp |
| 1258 | clamp opening |
| 1260 | rotatable fishing rod holder support stanchion member |
| 1262 | anchoring post |
| 1264 | proximal end |
| 1266 | distal end |
| 1268 | locking notched end |
| 1280 | goalpost configuration |
| 1316 | first opposing end |
| 1318 | second opposing end |
| 1320 | first vertical holding post |
| 1322 | second vertical holding post |
| 1326 | outer wall surface |
| 1330 | adjustable locking block member |
| 1332 | upper locking block section |
| 1334 | lower locking block section |
| 1336 | top wall surface of upper locking block section |
| 1338 | upper locking block threaded mounting openings |
| 1340 | mounting bolts |
| 1342 | bottom wall surface of upper locking block section |
| 1344 | upper block splined section |
| 1346 | top wall surface of lower locking block section |
| 1348 | lower locking block threaded mounting openings |
| 1350 | lower block splined section |
| 1352 | bottom wall surface of lower locking block section |
| 1372 | first L-shaped holding post member |
| 1374 | second L-shaped holding post member |
| 1376 | first horizontal crossbar member |
| 1378 | second horizontal crossbar member |
| 1380 | first inner ends |
| 1382 | second inner ends |
| 1384 | first crossbar splined section |
| 1386 | second crossbar splined section |

THIRD ALTERNATE EMBODIMENT 2000

| | |
|---|---|
| 2000 | fishing rod holder assembly |
| 2020 | fishing rod holder |
| 2022 | rod holder member |
| 2024 | outer wall surface |
| 2026 | inner wall surface |
| 2028 | fishing rod opening |
| 2030 | proximal end |
| 2032 | distal end |
| 2034 | rod holding pin |
| 2036 | connecting arm |
| 2038 | first end |
| 2040 | second end |
| 2042 | centrally located position |
| 2060 | fishing rod holder support stanchion member |
| 2062 | anchoring post |
| 2064 | proximal end |
| 2066 | proximal end |
| 2068 | locking notched end |
| 2070 | horizontal crossbar member |
| 2072 | first opposing end |
| 2074 | second opposing end |
| 2076 | first vertical holding post |
| 2078 | second vertical holding post |
| 2080 | goalpost configuration |
| 2082 | integrally connected singly constructed unit |
| 2084 | outer wall surface |
| 2086 | centrally placed position |
| 2090 | flush mounted rod holder |
| 2092 | mounting rim |

FOURTH ALTERNATE EMBODIMENT 3000

| | |
|---|---|
| 3000 | fishing rod holder assembly |
| 3020 | fishing rod holder |
| 3022 | rod holder member |
| 3024 | outer wall surface |
| 3026 | inner wall surface |
| 3028 | fishing rod opening |
| 3030 | proximal end |
| 3032 | distal end |
| 3034 | rod holding pin |
| 3036 | connecting arm |
| 3038 | first end |
| 3040 | second end |
| 3042 | centrally located position |
| 3060 | fishing rod holder support stanchion member |
| 3062 | anchoring post |
| 3064 | proximal end |
| 3066 | distal end |
| 3068 | locking notched end |
| 3070 | horizontal crossbar member |
| 3072 | first opposing end |
| 3074 | second opposing end |
| 3076 | first vertical holding post |
| 3078 | second vertical holding post |
| 3080 | goalpost configuration |
| 3084 | outer wall surface |
| 3086 | centrally placed location |
| 3090 | flush mounted rod holder |
| 3092 | mounting rim |
| 3330 | retaining collar assembly |
| 3332 | upper movable sleeve collar |
| 3334 | upper sleeve opening |
| 3336 | plurality of equally spaced-apart set screw openings |
| 3338 | set screws |
| 3340 | inner wall surface |
| 3342 | first pin joint tab |
| 3344 | pin opening |
| 3345 | holding pin |
| 3346 | movable pin joint flexing arm |
| 3348 | first end |
| 3349 | first pin opening |
| 3350 | second end |
| 3351 | second pin opening |
| 3352 | pin opening |
| 3354 | center movable sleeve collar |
| 3356 | center sleeve opening |
| 3358 | plurality of equally spaced-apart set screw openings |
| 3360 | second pin joint tab |
| 3362 | pin opening |
| 3364 | pin opening |
| 3366 | lower circumferential perimeter edge |
| 3368 | plurality of interlocking square-shaped ratchet teeth |
| 3370 | lower movable sleeve collar |
| 3372 | lower sleeve opening |
| 3374 | plurality of equally spaced-apart set screw openings |
| 3376 | upper circumferential perimeter edge |
| 3378 | plurality of interlocking square-shaped ratchet teeth |
| 3382 | proximal end of first vertical holding post |
| 3384 | proximal end of second vertical holding post |
| 3386 | distal end of first vertical holding post |
| 3388 | distal end of second vertical holding post |
| 3390 | threaded end of first vertical holding post |
| 3392 | threaded end of second vertical holding post |
| 3394 | first threaded end retaining cap |
| 3396 | second threaded end retaining cap |

FIFTH ALTERNATE EMBODIMENT 4000

| | |
|---|---|
| 4000 | fishing rod holder assembly |
| 4020 | fishing rod holder |
| 4022 | rod holder member |
| 4024 | outer wall surface |
| 4026 | inner wall surface |
| 4028 | fishing rod opening |
| 4030 | proximal end |
| 4032 | distal end |
| 4034 | rod holding pin |
| 4036 | connecting arm |
| 4038 | first end |
| 4040 | second end |
| 4042 | centrally located position |
| 4060 | fishing rod holder support stanchion member |
| 4062 | anchoring post |
| 4064 | proximal end |
| 4066 | distal end |
| 4068 | locking notched end |
| 4070F | flat horizontal crossbar member |
| 4072 | first opposing end |
| 4074 | second opposing end |
| 4076 | first vertical holding post |
| 4078 | second vertical holding post |
| 4080 | goalpost configuration |
| 4084 | outer wall surface |
| 4086 | centrally located position |
| 4090 | flush mounted rod holder |
| 4092 | mounting rim |
| 4382 | proximal end of first vertical holding post |
| 4384 | proximal end of second vertical holding post |
| 4386 | distal end of first vertical holding post |
| 4388 | distal end of second vertical holding post |
| 4540 | ratchet locking assembly |
| 4542 | upper ratchet locking collar |
| 4544 | upper collar opening |
| 4546 | lower circumferential perimeter edge |
| 4548 | plurality of interlocking square-shaped ratchet teeth |
| 4550 | first end cap member |
| 4552 | second end cap member |
| 4554 | first centrally located opening |
| 4556 | second centrally located opening |
| 4558 | first locking nut |
| 4560 | second locking nut |
| 4562 | adjustment bolt |
| 4564 | lower ratchet locking collar |
| 4566 | lower collar opening |
| 4568 | upper circumferential perimeter edge |
| 4570 | plurality of interlocking square-shaped ratchet teeth |
| 4572 | first bolt opening |
| 4574 | second bolt opening |

SIXTH ALTERNATE EMBODIMENT 5000

| | |
|---|---|
| 5000 | fishing rod holder assembly |
| 5060 | fishing rod holder support stanchion member |
| 5062 | anchoring post |
| 5064 | proximal end |
| 5066 | distal end |
| 5068 | locking notched end |
| 5070F | flat horizontal crossbar member |
| 5072 | first opposing end |
| 5074 | second opposing end |
| 5080 | goalpost configuration |
| 5090 | flush mounted rod holder |
| 5092 | mounting rim |
| 5108 | sleeve opening |
| 5540 | ratchet locking assembly |
| 5542 | upper ratchet locking collar |
| 5544 | upper collar opening |
| 5546 | lower circumferential perimeter edge |
| 5548 | plurality of interlocking square-shaped ratchet teeth |
| 5550 | first end cap member |
| 5552 | second end cap member |
| 5554 | first centrally located opening |
| 5556 | second centrally located opening |
| 5558 | first locking nut |
| 5560 | second locking nut |
| 5562 | adjustment bolt |
| 5564 | lower ratchet locking collar |
| 5566 | lower collar opening |
| 5568 | upper circumferential perimeter edge |
| 5570 | plurality of interlocking square-shaped ratchet teeth |
| 5572 | first bolt opening |
| 5574 | second bolt opening |
| 5750 | multiple angle fishing rod holder member |
| 5752 | housing member |
| 5754 | upper compartment section |
| 5756 | vertical holding stanchion member |
| 5758 | proximal end |
| 5760 | first interior holding compartment |
| P₁ | first angled position 90° |
| 5762 | second interior holding compartment |
| P₂ | second angled position of 60° |
| 5764 | third interior holding compartment |
| P₃ | third angled position of 45° |
| 5766 | fourth interior holding compartment |
| P₄ | fourth angled position of 30° |
| 5768 | first end wall plate |
| 5770 | first separating wall plate |
| 5772 | second separating wall plate |
| 5774 | third separating wall plate |
| 5776 | second end wall plate |
| 5778 | first locking pin opening |
| 5780 | second locking pin opening |
| 5782 | removable holding and locking pin |

SEVENTH ALTERNATE EMBODIMENT 6000

| | |
|---|---|
| 6000 | fishing rod holder assembly |
| 6062M | modified anchoring post |
| 6064 | proximal end |
| 6066 | distal end |
| 6068 | locking notched end |
| 6090 | flush mounted rod holder |
| 6092 | mounting rim |
| 6094 | plurality of countersunk mounting openings |
| 6096 | mounting bolt/screw |
| 6098 | tubular body member |
| 6100 | rod holder opening |
| 6102 | proximal end |
| 6104 | distal end |
| 6106 | plastic/rubber sleeve |
| 6108 | sleeve opening |
| 6110 | safety gimbal pin |
| 6540 | ratchet locking assembly |
| 6542 | upper ratchet locking collar |
| 6544 | upper collar opening |
| 6546 | lower circumferential perimeter edge |
| 6548 | plurality of interlocking square-shaped ratchet teeth |
| 6550 | end cap member |
| 6554 | centrally located opening |
| 6562 | adjustment bolt |
| 6564 | lower ratchet locking collar |
| 6566 | lower collar opening |
| 6568 | upper circumferential perimeter edge |
| 6570 | plurality of interlocking square-shaped ratchet teeth |
| 6750 | multiple angle fishing rod holder member |
| 6752 | housing member |
| 6754 | upper compartment section |
| 6756 | vertical holding stanchion member |
| 6758 | proximal end |
| 6760 | first interior holding compartment |
| P₁ | first angled position 90° |
| 6762 | second interior holding compartment |
| P₂ | second angled position of 60° |
| 6764 | third interior holding compartment |
| P₃ | third angled position of 45° |
| 6766 | fourth interior holding compartment |
| P₄ | fourth angled position of 30° |
| 6768 | first end wall plate |
| 6770 | first separating wall plate |
| 6772 | second separating wall plate |
| 6774 | third separating wall plate |
| 6776 | second end wall plate |
| 6778 | first locking pin opening |
| 6780 | second locking pin opening |
| 6782 | removable holding and locking pin |
| 6810 | integrally attached end cap member |
| 6812 | centrally located opening |
| 6814 | integrally attached locking nut |

FIRST ALTERNATE CONFIGURATION 7000 OF
THE SEVENTH ALTERNATE EMBODIMENT

| | |
|---|---|
| 7000 | fishing rod holder assembly |
| 7062A | angled anchoring post |
| 7064 | proximal end |
| 7066 | distal end |
| 7068 | locking notched end |
| 7090 | flush mounted rod holder |
| 7092 | mounting rim |
| 7096 | mounting bolt/screw |
| 7098A | angled tubular body member |
| 7102 | proximal end |
| 7104 | distal end |
| 7106 | plastic/rubber sleeve |
| 7108 | sleeve opening |
| 7110 | safety gimbal pin |
| 7540 | ratchet locking assembly |
| 7542 | upper ratchet locking collar |
| 7548 | plurality of interlocking square-shaped ratchet teeth |
| 7564 | lower ratchet locking collar |
| 7570 | plurality of interlocking square-shaped ratchet teeth |
| 7750 | multiple angle fishing rod holder member |
| 7752 | housing member |
| 7754 | upper compartment section |
| 7756 | vertical holding stanchion member |
| 7758 | proximal end |
| 7760 | first interior holding compartment |
| P₁ | first angled position 90° |
| 7762 | second interior holding compartment |
| P₂ | second angled position of 60° |
| 7764 | third interior holding compartment |
| P₃ | third angled position of 45° |
| 7766 | fourth interior holding compartment |
| P₄ | fourth angled position of 30° |
| 7778 | first locking pin opening |
| 7780 | second locking pin opening |
| 7782 | removable holding and locking pin |

SECOND ALTERNATE CONFIGURATION 8000
OF THE SEVENTH ALTERNATE EMBODIMENT

| | |
|---|---|
| 8000 | fishing rod holder assembly |
| 8062M | modified anchoring post |
| 8064 | proximal end |
| 8066 | distal end |
| 8068 | locking notched end |
| 8090 | flush mounted rod holder |
| 8092 | mounting rim |
| 8094 | countersunk mounting openings |
| 8096 | mounting bolt |
| 8098 | tubular body member |
| 8100 | rod holder opening |
| 8102 | proximal end |
| 8104 | distal end |
| 8106 | plastic/rubber sleeve |
| 8108 | sleeve opening |
| 8110 | safety gimbal pin |
| 8540 | ratchet locking assembly |
| 8542 | upper ratchet locking collar |
| 8548 | plurality of interlocking square-shaped ratchet teeth |
| 8564 | lower ratchet locking collar |
| 8570 | plurality of interlocking square-shaped ratchet teeth |
| 8750D | an alternately designed multiple angle fishing rod holder member |
| 8752 | housing member |
| 8754 | upper compartment section |
| 8756 | vertical holding stanchion member |
| 8758 | proximal end |
| 8760C | first interior holding compartment |
| P₁ | first angled position 90° |
| 8762C | second interior holding compartment |
| P₂ | second angled position of 60° |
| 8764C | third interior holding compartment |
| P₃ | third angled position of 45° |
| 8766C | fourth interior holding compartment |
| P₄ | fourth angled position of 30° |
| 8788 | first locking pin opening |
| 8780 | second locking pin opening |
| 8782 | removable holding and locking pin |

### DESCRIPTION OF THE PREFERRED AND ALTERNATE EMBODIMENTS

### Overview

The fishing rod holder assemblies 10, 200, 400, 600, 800, 1000, 2000, 3000, 4000, 5000, 6000, 7000 and 8000 and their component parts of the preferred and alternate embodiments are represented in detail by FIGS. 1 through 38 of the patent drawings. The fishing rod holder assemblies 10, 200, 400, 600, 800, 1000, 2000, 3000, 4000, 5000, 6000, 7000 and 8000 are used for fishing and/or trolling of large game fish, such as tuna, sailfish, shark and the like, from a pleasure or commercial fishing boat, trawler, yacht and sailing craft. Each of the fishing rod holder assemblies 10, 200, 400, 600, 800, 1000, 2000, 3000, 4000, 5000, 6000, 7000 and 8000 include a fishing rod holder 20, 220, 420, 620, 820, 1020, 1220, 2020, 3020, 4020, 5750, 6750, 7750 and 8750D, for mounting to a fishing rod holder support stanchion member 60, 260, 460, 660, 860, 1060, 1260, 2060, 3060, 4060 and 5060 in combination with a flush mounted rod holder 90, 290, 490, 690, 890, 1090, 2090, 3090, 4090, 5090, 6090, 7090 and 8090, respectively, in order to allow fishing boats 14 having limited gunwale 16 space to fish, troll or hold two or more fishing rods 12 within multiple (two or more) mountable or stationary fishing rod holders 20, 220, 420, 620, 820, 1020, 1220, 2020, 3020, 4020, and 5750 thereto, as depicted in FIGS. 1, 6 to 9, 11, 14, 15, 17, 21 and 25 of the drawings. As shown in FIGS. 34 through 38, the fishing rod holder assemblies 6000, 7000 and 8000 include a vertical anchoring post 6062, 7062 and 8062 having a single rotatable multiple angle fishing rod holder member 6750, 7750 and 8750, respectively, for holding only one fishing rod 12 thereto. Alternate embodiments 3000, 4000, 5000, 6000, 7000 and 8000 include a retaining locking collar assembly 3330 and ratchet locking assemblies 4540, 5540, 6540, 7540 and 8540 having a plurality of interlocking square-shaped ratchet teeth 3368 and 3378, 4548 and 4570, 5548 and 5570, 6548 and 6570, 7548 and 7570, and 8548 and 8570 on sleeve or locking collars 3352 and 3354, 4542 and 4564, 5542 and 5564, 6542 and 6564, 7542 and 7564, and 8542 and 8564, respectively, in order to rotate in clockwise or counterclockwise rotational movement C₁, R₁ or C₂, R₂ of each of the fishing rod holders 20, 220, 420, 620, 820, 1020, 1220, 2020, 3020, 4020, 5750, 6750, 7750 and 8750D to a desired position by the user, accordingly. It is understood that the interlocking ratchet teeth 3368 and 3378, 4548 and 4570, 5548 and 5570, 6548 and 6570, 7548 and 7570, and 8548 and 8570 of the retaining collar assembly 3330 and ratchet locking assemblies 4540, 5540, 6540, 7540 and 8540 can include saw-shaped teeth, sinoidal-shaped teeth or non-skid contact surfaces in place of the square-shaped interlocking ratchet teeth as indicated in the above. The fishing rod holder support stanchion members 60, 260, 460, 660, 860, 1060, 1260, 2060, 3060, 4060 and 5060 are made from metal or plastic materials being saltwater (rust) resistant that ate selected from the group consisting of steel, stainless steel, aluminum or titanium and durable plastics.

### Preferred Embodiment 10

The fishing rod holder assembly 10 and its component parts of the preferred embodiment of the present invention are represented in detail by FIGS. 1 through 5 of the patent drawings. The fishing rod holder assembly 10 includes one or more fishing rod holders 20 detachably mounted to a fishing rod holder support stanchion member 60 being detachably mounted to a flush mounted rod holder 90 that is mounted to a gunwale 16 of a fishing boat 14.

The fishing rod holders 20 each including a rod holder member 22 having an outer wall surface 24, an inner wall surface 26 for forming a fishing rod opening 28 for slidably receiving a fishing rod handle 12h of fishing rod 12 therethrough. The rod holder member 22 further includes a proximal end 30 and a distal end 32. The proximal end 30 includes a rod holding pin 34 for securing and receiving a handle locking notch 12n of the fishing rod handle 12h of fishing rod 12, as depicted in FIG. 2 of the drawings, within the rod opening 28 of the fishing rod holder 20. The rod holder member 22 also includes a connecting arm 36 having a first end 38 and a second end 40. The first end 38 of connecting arm 36 being integrally attached to a centrally located position 42 on the outer wall surface 24 of the rod holder member 22 of fishing rod holder 20. The second end 40 of connecting arm 36 includes an integrally attached adjustable holding bracket/clamp 44 for attaching to the support stanchion member 60. The adjustable holding clamp 44 includes a first curved clamping section 46 and a second curved clamping section 48. Each of the first and second curved clamping sections 46 and 48 being held together by a plurality of holding bolts 50 via a pair of opposing clamp tabs 52a and 52b on the first curved clamping section 46 and a pair of opposing clamping tabs 54a and 54b on the second curved clamping section 48. Each of the of the opposing clamping tabs 52a and 52b, and 54a and 54b include a plurality of countersunk mounting openings 56 on each of the first and second curved clamping sections 46 and 48, respectively, for receiving the mounting bolts therethrough for assembling of the adjustable holding clamps 44. When assembled, the opposing clamping tabs 52a and 54a, and 52b and 54b are matched together (adjacent to each other) of the opposing first and second curved clamping sections 46 and 48 for forming the assembled adjustable holding clamp 44 having a clamp opening 58. The second curved clamping section 48 is integrally attached to the second end 40 of the connecting arm 36, as shown in FIGS. 1 through 3 of the drawings. Each of the fishing rod holders 20, as shown in FIGS. 2 and 3, can move independently in an upward or downward movement M₁ or M₂, as well as in a clockwise or counterclockwise rotation C₁ or C₂, on each of the vertical holding posts 76 and 78, accordingly, of fishing rod holder support stanchion member 60.

The fishing rod holder support stanchion member 60, as shown in FIGS. 2, 5 and 6, includes an anchoring post 62 being cylindrically shaped and having a proximal end 64 and a distal end 66. The proximal end 64 having a locking notched end 68. The support stanchion member 60 further includes a horizontal crossbar member 70 having opposing ends 72 and 74. At each of the opposing ends 72 and 74 include integrally connected vertical holding posts 76 and 78, respectively, for forming a goalpost configuration 80. As shown in FIGS. 4 and 5, the vertical holding posts 76 and 78 are slightly skewed from a vertical Y-axis, position Y each having angle a in the range of 0° to 90° from the Y-axis position Y. The fishing rod holder support stanchion member 60 has incorporated the anchoring post 62, the horizontal crossbar member 70 and the vertical holding posts 76 and 78 into an integrally connected singly constructed unit 82 by means of welding and/or tubular bending for forming the goalpost configuration 80 having an outer wall surface 84. The support stanchion member 60 is made from metal or plastic materials selected from the group consisting of aluminum, steel, stainless steel, steel alloys and titanium, as well as durable plastics.

The flush mounted rod holder 90 includes a mounting rim 92 having a plurality of countersunk mounting openings 94 therein each for receiving a mounting bolt/screw 96 therethrough for attachment to the gunwale 16 of fishing boat 14. The flush mounted rod holder 90 further includes a tubular body member 98 being integrally attached to the mounting rim 92. The tubular body member 98 having an opening 100, a proximal end 102 and a distal end 104. The opening 90 of tubular body member 98 is for receiving a plastic/rubber sleeve 106 having a sleeve opening 108 therethrough. The proximal end 102 of tubular body member 98 includes an attached safety gimbal pin 110. The sleeve opening 108 of plastic/rubber sleeve 106 is used for receiving the anchoring post 62 of the support stanchion member 60 therethrough, such that the locking notched end 68 of anchoring post 62 is detachably connected to the safety gimbal pin 110 of the flush mounted rod holder 90 in which to hold in place the support stanchion member 60 with the flush mounted rod holder 90, as shown in FIGS. 1 and 3 of the drawings.

The fishing rod holder assembly 200 and its component parts of the first alternate configuration of the preferred embodiment of the present invention is represented in detail by FIG. 6 of the patent drawings. Elements illustrated in FIG. 6, which correspond to the elements described above with reference to FIGS. 1 to 3, have been designated by corresponding reference numbers increased by two hundred. The first alternate configuration 200 of the preferred embodiment is similarly constructed and operates in the same manner as the preferred embodiment 10, unless it is otherwise stated. All aspects of the first alternate configuration of the fishing rod holder support stanchion member 260 of the fishing rod holder assembly 200 are the same as the fishing rod holder support stanchion member 60 of the fishing rod holder assembly 10 except for the shape and configuration of the vertical holding posts 397 and 399 being integrally connected at each of the opposing ends 272 and 274 on horizontal crossbar member 270. As shown in FIG. 6, vertical holding post 397 is slightly skewed from a vertical Y-axis position Y′ having an angle alpha (α) in the range of 0° to 90° from the Y-axis position Y′, and vertical holding post 399 is slightly/moderately skewed from a vertical Z-axis position Z′ having an angle beta (β) in the range of 0° to 90° from the Z-axis position Z′. In all other respects, the fishing rod holder support stanchion member 260 is similar to the preferred embodiment of the fishing rod holder support stanchion member 60 except for the first alternate configuration showing the slightly angled vertical holding post 397 relative to the moderately angled vertical holding post 399 for forming a skewed/angled goalpost configuration 2805.

The fishing rod holder assembly 400 and its component parts of the second alternate configuration of the preferred embodiment is represented in detail by FIG. 7 of the patent drawings. Elements illustrated in FIG. 7, which correspond to the elements described above with reference to FIGS. 1 to 3, have been designated by corresponding reference numbers increased by four hundred. The second alternate configuration 400 of the preferred embodiment is similarly constructed and operates in the same manner as the preferred embodiment 10, unless it is otherwise stated. All aspects of the second alternate configuration of the fishing rod holder support stanchion member 460 of the fishing rod holder assembly 400 are the same as the fishing rod holder support stanchion member 60 of the fishing rod holder assembly 10 except for the shape and configuration of a pair of angled vertical holding posts 526 and 528 being integrally connected to the distal end 466 of the anchoring post 462. The holder support stanchion member 460 of this second alternate configuration does not include a horizontal crossbar member 70, as depicted in FIG. 5, of the preferred embodiment of the holder support stanchion member 60. As depicted in FIG. 7, each of the angled vertical holding posts 526 and 528 are slightly skewed from a vertical Y-axis position Y″ each having an angle gamma (γ) in the range of 0° to 90° from the Y-axis position Y″. In all other respects, the fishing rod holder support stanchion member 460 is similar to the preferred embodiment of the fishing rod holder support stanchion member 60 except for the second alternate configuration showing the pair of angled vertical holding posts 526 and 528 being integrally connected to the distal end 466 of anchoring post 462 for forming a Y-shaped configuration 530 (see FIG. 7).

The fishing rod holder assembly 600 and its component parts of the third alternate embodiment is represented in detail by FIG. 8 of the patent drawings. Elements illustrated in FIG. 8, which correspond to the elements described above with reference to FIGS. 1 to 3, have been designated by corresponding reference numbers increased by six hundred. The third alternate configuration 600 of the preferred embodiment is similarly constructed and operates in the same manner as the preferred embodiment 10, unless it is otherwise stated. All aspects of the third alternate configuration of the fishing rod holder support stanchion member 660 of the fishing rod holder assembly 600 are the same as the fishing rod holder support stanchion member 60 of the fishing rod holder assembly 10 except for the overall shape and configuration of the holder support stanchion member 660 having an additional center vertical holding post 738 being integrally attached to an elongated horizontal crossbar member 670. Additionally, the anchoring post 662 is integrally attached on the crossbar member 670 between the center -vertical holding post 738 and the first vertical holding post 676, as depicted in FIG. 8 of the drawings. In all other respects, the fishing rod holder support stanchion member 660 is similar to the preferred embodiment of the fishing rod holder support stanchion member 60 except for the third alternate configuration of the vertical holding posts 676, 738 and 678 being integrally attached to the elongated horizontal crossbar member 670 for forming a trident-shaped goalpost configuration 740.

The fishing rod holder assembly 800 and its component parts of the fourth alternate configuration of the preferred embodiment is represented in detail by FIG. 9 of the patent drawings. Elements illustrated in FIG. 9, which correspond to the elements described above with reference to FIG. 8, have been designated by corresponding reference numbers increased by two hundred. The fourth alternate configuration 800 of the preferred embodiment is similarly constructed and operates in the same manner as the third alternate embodiment 600, the preferred embodiment 10, unless it is otherwise stated. All aspects of the fourth alternate configuration of the fishing rod holder support stanchion member 860 of the fishing rod holder assembly 800 are exactly the same as the fishing rod holder support stanchion member 60 of the fishing rod holder assembly 10 except for the overall shape and configuration of the holder support stanchion member 860 having an L-shaped telescoping member 942. The L-shaped telescoping member 942 includes a vertical holding post 944 and a horizontal crossbar section 946 having an opening 948 therethrough. The horizontal crossbar section 946 includes a turn-stop opening 950 for receiving a turn-stop member 952 therethrough. The crossbar member 870 includes a plurality of turn-stop crossbar openings 954 for receiving the turn-stop member 952 therethrough. The second end 874 of crossbar member 870 is slidably received within opening 948 of the horizontal crossbar section 946 of the L-shaped telescoping member 942 in order to adjust the appropriate length of the horizontal crossbar member 870 when the turn-stop member 952 is tightened within adjacent openings 950 and 954, accordingly, as shown in FIG. 9 of the drawings. In all other respects, the fishing rod holder support stanchion member 860 is exactly the same as the fishing rod holder support stanchion member 60 except for the fourth alternate configuration of the L-shaped telescoping member 942 being slidably adjusted along the second end 874 of the elongated horizontal crossbar member 870 for forming an adjustable trident-shaped goalpost configuration 960.

### Second Alternate Embodiment 1000

The fishing rod holder assembly 1000 and its component parts of the second alternate embodiment are represented in detail by FIGS. 10 through 13 of the patent drawings. Elements illustrated in FIGS. 10 to 13 which correspond to the elements described above with reference to FIGS. 1 to 3 have been designated by corresponding reference numbers increased by one thousand. The second alternate embodiment 1000 is similarly constructed and operates in the same manner as the preferred embodiment 10, unless it is otherwise stated. The fishing rod holder assembly 1000 includes a rotatable fishing rod holder support stanchion member 1060. The rotatable fishing rod holder support stanchion member 1060 includes a U-shaped holding post member 1112 having a horizontal crossbar member 1114 having opposing ends 1116 and 1118. At each of the opposing ends 1116 and 1118 include an integrally connected vertical holding post 1120 and 1122. The horizontal crossbar member 1114 includes a centrally located crossbar splined section 1124 being circumferentially machined on an outer wall surface 1126 of the crossbar member 1114, as depicted in FIG. 11 of the drawings. The holder support stanchion member 1110 further includes an adjustable locking block member 1130 having an upper locking block section 1132 and a lower locking block section 1134, as shown in FIGS. 11 to 13 of the drawings. The upper locking block section 1132 includes a top wall surface 1136 having a plurality of upper block threaded mounting openings 1138 for receiving mounting bolts 1140 therethrough. The upper locking block section 1132 also includes a bottom wall surface 1142 having an upper block splined section 1144 being U-shaped in configuration. The lower locking block section 1134 includes a top wall surface 1146 having a plurality of lower locking block threaded mounting openings 1148 for receiving mounting bolts 1140 therethrough and having a lower block splined section 1150 being U-shaped in configuration. The upper and lower block splined sections 1144 and 1150 rotatably and detachably engage the centrally located crossbar splined section 1124, as shown in FIGS. 12 and 13 of the drawings. The upper and lower locking block sections 1132 and 1134 are joined together via the matching of the upper and lower block mounting threaded openings 1138 and 1148 (threaded openings 1138 and 1148 are adjacent to each other), respectively, for attaching and joining the upper and lower locking block sections 1132 and 1134 around the centrally located crossbar splined section 1124 of horizontal crossbar member 1114, as shown in FIGS. 12 and 13 of the drawings. The lower locking block section 1134 also includes a bottom wall surface 1152. The bottom wall surface 1152 is integrally attached to the distal end 1066 of anchoring post 1062. The proximal end 1064 of anchoring post 1062 includes the locking notched end 1068. The joined locking block member 1130, the U-shaped holding post member 1112 and the anchoring post 1062 are assembled together to form a goalpost configuration 1080, as shown in FIG. 10 of the drawings. Each of the fishing rod holder 1020, as shown in FIG. 11, can move independently in an upward or downward movement M₁ or M₂, as well as in a clockwise or counterclockwise rotation C₁ or C₂, on each of the vertical holding posts 1120 and 1122 of the U-shaped holding post member 1112, accordingly of the rotatable fishing rod holder support stanchion member 1060. Additionally, the U-shaped holding post member 1112 can rotate in a clockwise or counterclockwise direction C₃ or C₄.

The fishing rod holder assembly 1200 and its component parts of the first alternate configuration of the second alternate embodiment of the present invention is represented in detail by FIG. 14 of the patent drawings. Elements illustrated in FIG. 14, which correspond to the elements described above with reference to FIGS. 10 to 13 have been designated by corresponding reference numbers increased by two hundred. The first alternate configuration 1200 of the second alternate embodiment is similarly constructed and operates in the same manner as the second alternate embodiment 1000, unless it is otherwise stated. All aspects of the first alternate configuration of the rotatable fishing rod holder support stanchion member 1260 of the fishing rod holder assembly 1200 are exactly the same as the fishing rod holder support stanchion member 1060 of the fishing rod holder assembly 1000 except for the shape and configuration of a pair of L-shaped holding post members 1372 and 1374 each having a horizontal crossbar member 1376 and 1378 and having an integrally connected vertical holding posts 1320 and 1322, respectively, as shown in FIG. 14 of the drawings. Each of the horizontal crossbar members 1376 and 1378 include an inner end 1380 and 1382 having a crossbar splined section 1384 and 1386, respectively, thereto. The crossbar splined sections 1384 and 1386 are circumferentially machined on the outer wall surface 1326 on each of the inner ends 1380 and 1382 of the horizontal crossbar members 1376 and 1378, respectively. Each of the fishing rod holders 1220, as shown in FIG. 14, can move independently in an upward or downward movement M₁ or M₂, as well as in a clockwise or counterclockwise rotation C₁ or C₂, on each of the vertical holding posts 1320 and 1322 of the L-shaped holding post members 1372 and 1374, respectively, of the rotatable fishing rod holder support stanchion member 1260. Each of the L-shaped holding post member 1372 and 1374 can be independently rotated in opposite directions in either a clockwise or counterclockwise rotation C₅ and C₆, as depicted in FIG. 14, within the adjustable locking block member 1330. In all other respects, the fishing rod holder support stanchion member 1260 is exactly the same as the second alternate embodiment of thefishing rod holder support stanchion member 1060 except for the first alternate configuration having opposing L-shaped holding post members 1372 and 1374 for forming a goalpost configuration 1280, when in the assembled configuration.

### Third Alternate Embodiment 2000

The fishing rod holder assembly 2000 and its component parts of the third alternate embodiment of the present invention are represented in detail by FIGS. 15 and 16 of the patent drawings. Elements illustrated in FIGS. 15 and 16 which correspond to the elements described above with reference to FIG. 1 to 3 have been designated by corresponding reference numbers increased by two thousand. The third alternate embodiment 2000 is similarly constructed and operates in the same manner as the preferred embodiment 10, unless it is otherwise stated. All aspects of the third alternate embodiment of the fishing rod holder assembly 2000 having fishing rod holder support stanchion member 2060 are exactly the same as the fishing rod holder assembly 10 having the fishing rod holder support stanchion member 60 of the preferred embodiment except that a permanently attached fishing rod holder 2020 is connected to each of the vertical holding posts 2076 and 2078, respectively. Each of the fishing rod holders 2020 include a rod holder member 2022 having an outer wall surface 2024, an inner wall surface 2026 for forming a fishing rod openings 2028 for slidably receiving a fishing rod handle 12h of fishing rod 12 therethrough. The rod holder member 2022 further includes a proximal end 2030 and a distal end 2032. The proximal end 2030 including a rod holding pin 2034 for securing and receiving of a handle locking notch 12n of the fishing rod handle 12h of fishing rod 12, as depicted in FIG. 15 of the drawings, within the fishing rod opening 2028 of the fishing rod holder 2020. The rod holder member 2022 also includes a connecting arm 2036 having a first end 2038 and a second end 2040. The first end 2038 of connecting arm 2036 being integrally attached by welding to a centrally located position 2042 on the outer wall surface 2024 of the rod holder member 2022 of fishing rod holder 2020. The second end 2040 of connecting arm 2036 is integrally attached by welding to a centrally placed position 2084 on an outer wall surface 2086 of the vertical holding post 2076 and/or 2078 of holder stanchion support member 2060, as depicted in FIG. 16 of the drawings. In all other respects, the fishing rod holder support stanchion member 2060 of fishing rod holder assembly 2000 of the third alternate embodiment is exactly the same as the fishing rod holder support stanchion member 60 of fishing rod holder assembly 10 of the preferred embodiment except for each of the permanently attached fishing rod holders 2020 on each of the vertical holding posts 2076 and 2078, accordingly, as shown in FIG. 15.

### Fourth Alternate Embodiment 3000

The fishing rod holder assembly 3000 and its component parts of the fourth alternate embodiment of the present invention are represented in detail by FIGS. 17 through 20 of the patent drawings. Elements illustrated in FIGS. 17 and 18 which correspond to the elements described above with reference to FIGS. 1 to 3 have been designated by corresponding reference numbers increased by three thousand. The fourth alternate embodiment 3000 is similarly constructed and operates in the same manner as the preferred embodiment 10, unless it is otherwise stated. All aspects of the fourth alternate embodiment of the fishing rod holder assembly 3000 having the fishing rod holder support stanchion member 3060 are exactly the same as the fishing rod holder assembly 10 having the fishing rod holder support stanchion member 60 of the preferred embodiment except for a retaining collar assembly 3330 that allows the fishing rod holder 3020 to move in an upward and/or downward movement M₁ and M₂, respectively, as well as an angle adjustment A from a vertical Y-axis position Y having an angle delta (δ) being in the range of 45° to 90° from the Y-axis Y position. Each of the fishing rod holders 3020 are movably connected to each of the vertical holding posts 3076 and 3078.

Each of the fishing rod holders 3020 include a rod holder member 3022 having an outer wall surface 3024, an inner wall surface 3026 for forming a fishing rod opening 3028 for slidably receiving a fishing rod handle 12h of fishing rod 12 therethrough. The rod holder member 3022 further includes a proximal end 3030 and a distal end 3032. The proximal end 3030 includes a rod holding pin 3034 for the securing and receiving of a handle locking notch 12n on the fishing rod handle 12h thereon, as depicted in FIG. 17 of the drawings, within the fishing rod opening 3028 of fishing rod holder 3020. The rod holder member 3022 also includes a connecting arm 3036 having a first end 3038 and a second end 3040. The first end 3038 of connecting arm 3036 being integrally attached by welding to a centrally located position 3042 on the outer wall surface 3024 of the rod holder member 3022 of fishing rod holder 3020. The second end 3040 of connecting arm 3036 is connected to the retaining collar assembly 3330, as depicted in FIGS. 17 and 18 of the drawings.

Each of the retaining collar assemblies 3330 includes an upper movable sleeve collar 3332 having an upper sleeve opening 3334, a center movable sleeve collar 3354 having a center sleeve opening 3356, and a lower movable sleeve collar 3370 having a lower sleeve opening 3372. The upper sleeve collar 3332 includes a plurality of equally spaced-apart set screw openings 3336 being circumferentially positioned along the upper sleeve collar 3332 for receiving set screws 3338 therethrough, as depicted in FIGS. 17 and 18 of the drawings. The upper sleeve collar 3332 includes an inner wall surface 3340 for slidably receiving each of the vertical holding posts 3076 and 3078 and for adjacently contacting the outer wall surface 3384 of the vertical holding posts 3076 and 3078. The upper movable sleeve collar 3332 further includes a first pin joint tab 3342 having a pin opening 3344 for receiving a holding pin 3345 therethrough. The upper movable sleeve collar 3332 also includes a movable pin joint flexing arm 3346 having a first end 3348 and a second end 3350. The first end 3348 of pin joint flexing arm 3346 is attached to the pin opening 3344 of pin joint tab 3342 via holding pin 3345. The second end 3350 of pin joint flexing arm 3346 is attached to a pin opening 3352 at the first end 3038 connecting arm 3036, as shown in FIGS. 17 and 18 of the drawings. The center movable sleeve collar 3354 includes a plurality of equally spaced-apart set screw openings 3358 being circumferentially positioned along the center sleeve collar 3354 for receiving set screws 3338 therethrough, as shown in FIGS. 17 to 20 of the drawings. The center movable sleeve collar 3354 further includes a second pin joint tab 3360 having a pin opening 3362 for receiving the holding pin 3345 therethrough. The second pin joint tab 3360 is attached to a pin opening 3364 at the second end 3040 of connecting arm 3036, as shown in FIGS. 17 and 18 of the drawings. The center movable sleeve collar 3354 also includes a lower circumferential perimeter edge 3366 having a plurality of interlocking square-shaped ratchet teeth 3368 thereon. The lower sleeve collar 3370 includes a plurality of equally spaced-apart set screw openings 3374 being circumferentially positioned along the lower movable sleeve collar 3370 for receiving set screws 3338 therethrough, as depicted in FIGS. 17 and 18 of the drawings. The lower movable sleeve collar 3370 further includes an upper circumferential perimeter edge 3376 having a plurality of interlocking square-shaped ratchet teeth 3378 thereon.

Each of the vertical holding posts 3076 and 3078 additionally includes a proximal end 3382 and 3384, and a distal end 3386 and 3388, respectively. The proximal ends 3382 and 3384 are adjacent to the first and second ends 3072 and 3074 of horizontal crossbar member 3070, respectively, as shown in FIG. 17 of the drawings. Each of the distal ends 3386 and 3388 include a threaded end 3390 and 3392 having a threaded end retaining cap 3394 and 3396 to prevent the removing of the retaining collar assemblies 3330 from each of the vertical holding posts 3076 and 3078, respectively, of fishing rod holder support stanchion member 3060, as shown in FIGS. 17 and 18 of the drawings. When assembling (see FIGS. 17 to 19), each of the fishing rod holders 3020 are slidably mounted to each of the vertical holding posts 3076 and 3078 via the retaining collar assemblies 3330, such that the threaded end caps 3394 and 3396 are removed from the threaded ends 3390 and 3392 of the distal ends 3386 and 3388 of vertical holding posts 3076 and 3078, respectively, as depicted in FIG. 17. Where then each of the sleeve openings 3334, 3356 and 3372 of movable sleeve collars 3332, 3354 and 3370 are slidably received on the distal ends 3386 and 3388 of vertical holding posts 3076 and 3078, respectively. Each of the movable sleeve collars 3332, 3354 and 3370 are then set in place via the set screws 3338 within set screw openings 3336, 3358 and 3374 on movable sleeve collars 3332, 3354 and 3370 on the outer wall surface 3084 of vertical holding posts 3076 and 3078, such that the user adjusts each of the retaining collar assemblies 3330 of fishing rod holders 3020 on each of the vertical holding posts 3076 and 3078 to a desired location, as shown in FIG. 17 of the drawings. Each of the fishing rod holders 3020, as shown in FIGS. 19 and 20, can move independently in an upward or downward movement M₁ or M₂, as well as in a clockwise or counterclockwise rotation C₁ and C₂, on each of the vertical holding posts 3076 and 3078, accordingly, of the fishing rod holder support stanchion member 3060. In all other respects, the fishing rod holder assembly 3000 of the fourth alternate embodiment is exactly the same as the fishing rod holder 20 and the fishing rod holder support stanchion member 60 of fishing rod holder assembly 10 of the preferred embodiment for each of the retaining collar assemblies 3330 on fishing rod holder 3020 being movably mounted to vertical holding posts 3076 and 3078 and the retaining collar assemblies being retained and not being removable from the vertical holding posts 3076 and 3078 via the threaded end caps 3394 and 3396, accordingly, as shown in FIGS. 17 to 20 of the drawings.

### Fifth Alternate Embodiment 4000

The fishing rod holder assembly 4000 and its component parts of the fifth alternate embodiment of the present invention are represented in detail by FIGS. 21 through 24 of the patent drawings. Elements illustrated in FIGS. 21 and 22, which correspond to the elements described above with reference to FIGS. 15 and 16, have been designated by corresponding reference numbers increased by two thousand. The fifth alternate embodiment 4000 is similarly constructed and operates in the same manner as the third alternate embodiment 2000, unless it is otherwise stated. All aspects of the fifth alternate embodiment of the fishing rod holder assembly 4000 having the fishing rod holder support stanchion member 4060 are exactly the same as the fishing rod holder assembly 2000 having the fishing rod holder support stanchion member 2060 of the third alternate embodiment except for a ratchet locking assembly 4540 on each of the vertical holding posts 4076 and 4078 which allows for the clockwise or counter-clockwise rotation R₁ or R₂ of each of the vertical holding posts 4076 and 4078 of the fishing rod holder support stanchion member 4060. Further, the fishing rod holder support stanchion member 4060 includes a flat crossbar member 4070F having an elongated rectangularly bar-shaped structure, as shown in FIGS. 21 and 22, replacing a tubular structure of the horizontal crossbar member 2070 and 70 of the third alternate embodiment and preferred embodiment, respectively (see FIGS. 3 and 16).

Each of the ratchet locking assemblies 4540 includes an upper ratchet locking collar 4542 having an upper collar opening 4544 and a lower ratchet locking collar 4564 having a lower collar opening 4566. The upper ratchet locking collar 4542 includes a lower circumferential perimeter edge 4546 having a plurality of interlocking square-shaped ratchet teeth 4548, thereon. The upper ratchet locking collar 4542 is permanently mounted via welding to the outer wall surface 4086 at each of the proximal ends 4382 and 4384 of vertical holding posts 4076 and 4078, respectively, of the fishing rod holder support stanchion member 4060, as shown in FIGS. 23 and 24 of the drawings. Each of the proximal ends 4382 and 4384 include an integrally attached end cap member 4550 and 4552 having a centrally located opening 4554 and 4556 with an integrally attached (via welding) locking nut 4558 and 4560 thereon, respectively, as depicted in FIGS. 23 and 24 of the drawings, for receipt of an adjustment bolt 4562 therethrough. The lower ratchet locking collar 4564 includes an upper circumferential perimeter edge 4568 having a plurality of interlocking square-shaped ratchet teeth 4570 thereon. The lower ratchet locking collar 4564 is permanently mounted via welding to the opposing ends 4072 and 4074 of the flat crossbar member 4070F, as shown in FIGS. 23 and 24 of the drawings.

Additionally, each of the opposing ends 4072 and 4074 of the flat crossbar member 4070F, as shown in FIGS. 23 and 24, includes bolt openings 4572 and 4574, respectively, for receiving the adjustment bolt 4562 therethrough. As depicted in FIGS. 23 and 24, the openings 4554 and 4556 of locking nuts 4558 and 4560 are vertically aligned with the bolt openings 4572 and 4574 at each end 4072 and 4074 of flat crossbar member 4070F, respectively, for receiving the adjustment bolt 4562 therethrough in order to engage and lock the upper interlocking ratchet teeth 4548 with the lower interlocking ratchet teeth 4570 (see FIG. 24).

When assembled, (see FIG. 24) the adjustment bolts 4562 engage the locking nuts 4558 and 4560 in which the proximal ends 4382 and 4384 of the vertical holding posts 4076 and 4078 are pulled through the lower collar openings 4566 of the lower ratchet locking collars 4564 such that the upper interlocking square-shaped ratchet teeth 4548 of upper ratchet locking collar 4542 engage the lower interlocking square-shaped ratchet teeth 4570 of lower ratchet locking collar 4564 for locking each of the ratchet locking assemblies 4540 in place, as shown in FIGS. 21, 22 and 24 of the drawings.

In all other respects, the fishing rod holder support stanchion member 4060 of fishing rod holder assembly 4000 of the fifth alternate embodiment is exactly the same as the fishing rod holder 2020 and the fishing rod holder support stanchion member 2060 of fishing rod holder assembly 2000 of the third alternate embodiment for each of the ratchet locking assemblies 4540 mountably attached to each of the opposing ends 4072 and 4074 of the flat crossbar member 4070F of the fishing rod holder support stanchion member 4060, as shown in FIG. 21.

### Sixth Alternate Embodiment 5000

The fishing rod holder assembly 5000 and its component parts of the sixth alternate embodiment of the present invention are represented in detail by FIGS. 25 to 33 of the patent drawings. Elements illustrated in FIGS. 25 and 26, which correspond to the elements described above with reference to FIGS. 21 to 24, have been designated by corresponding reference numbers increased by one thousand. The sixth alternate embodiment 5000 is similarly constructed and operates in the same manner as the fifth alternate embodiment 4000, unless it is otherwise stated. All aspects of the sixth alternate embodiment of the fishing rod holder assembly. 5000 having the fishing rod holder support stanchion member 5060 are exactly the same as the fishing rod holder assembly 4000 having the fishing rod holder support stanchion member 4060 of the fourth alternate embodiment except for a multiple angle fishing rod holder member 5750 that allows the placement of the fishing rod handle 12h of fishing rod 12 to be angled by a user for an appropriate trolling and/or holding angle.

The multiple angle fishing rod holder member 5750 includes a housing member 5752 being substantially L-shaped in configuration. The housing member 5752 includes an upper compartment section 5754 being integrally connected to a vertical holding stanchion member 5756 having a proximal end 5758, as shown in FIGS. 26 and 27 of the drawings. The upper compartment section 5754 includes a plurality of interior holding compartments 5760, 5762, 5764 and 5766 for the angled positioning of a fishing rod handle 12h of fishing rod 12 therein. Each of the interior holding compartments 5760, 5762, 5764 and 5766 include compartment end plates 5768 and 5776 and separating wall plates 5770, 5772 and 5774 for the angled alignment of each of the interior holding compartments 5760, 5762, 5764 and 5766, respectively, of the multiple angle fishing rod holder member 5750, as shown in FIGS. 25 to 27 of the drawings. In particular, as shown in FIG. 30, the fishing rod 12 is held in a first angles position PI having a 90° alignment within the first interior holding compartment 5760. As shown in FIG. 31, the fishing rod 12 is held in a second angled position P₂ having a 60° alignment within the second interior holding compartment 5762. As shown in FIG. 32, the fishing rod 12 is held in a third angled position P₃ having a 45° alignment within the third interior holding compartment 5764. As shown in FIG. 33, the fishing rod 12 is held in a fourth angled position P₄ having a 30° alignment within the fourth interior holding compartment 5766.

The proximal end 5758 of the vertical holding stanchion member 5756 includes first and second locking pin openings 5778 and 5780 for receiving a removable holding and locking pin 5782 therethrough, as depicted in FIGS. 28 and 29 of the drawings. The removable locking pin 5782 is used to detachably receive the handle locking notch 12n of a gimbaled butt end 12g of fishing rod 12, as shown in FIGS. 28 and 29 of the drawings, in which to anchor the fishing rod 12 within one of the interior holding compartments 5760, 5762, 5764 and 5766, accordingly. Additionally, the upper ratchet locking collar 5542 of the ratchet locking assembly 5540 is permanently attached via welding to the proximal end 5758 of the vertical holding stanchion member 5756 of the multiple angle fishing rod member 5750, as depicted in FIG. 26 of the drawings.

In all other respects, the ratchet locking assembly 5540 of the fishing rod holder support stanchion member 5060 of fishing rod holder assembly 5000 is exactly the same as the ratchet locking assembly 4540 of the fishing rod holder support stanchion member 4060 of fishing rod holder assembly 4000 of the fifth alternate embodiment except for the replacing of the fishing rod holder 4020 and the vertical posts 4076 and 4078 (see FIG. 21) with that of the multiple angle fishing rod holder member 5750, as shown in FIG. 25 of the drawings.

### Seventh Alternate Embodiment 6000

The fishing rod holder assembly 6000 and its component parts of the seventh alternate embodiment of the present invention are represented in detail by FIGS. 34 and 35 of the patent drawings. Elements illustrated in FIGS. 34 and 35 which correspond to the elements described above with reference to FIGS. 25 and 26 have been designated by corresponding reference numbers increased by one thousand. The seventh alternate embodiment 6000 is similarly constructed and operates in the same manner as the sixth alternate embodiment 5000, unless it is otherwise stated. All aspects of the seventh alternate embodiment of the fishing rod holder assembly 6000 having the multiple angle fishing rod holder member 6750 are exactly the same as the fishing rod holder assembly 5000 having the multiple angle fishing rod holder member 5750 of the sixth alternate embodiment and except for a modified anchoring post 6062M having the lower ratchet locking collar 6564 of the ratchet locking assembly 6540 being attached to the distal end 6066 of the modified anchoring post 6062M, as shown in FIGS. 35 and 36. The modified anchoring post 6062M and the ratchet locking assembly 6540 is used to only hold a single multiple angle fishing rod holder member 6750 thereon, as shown in FIG. 34. The distal end 6066 of the modified anchoring post 6062M includes an integrally attached end cap member 6810 having a centrally located opening 6812 with an integrally attached (via welding) locking nut 6814 thereon, as depicted in FIGS. 35 and 36 of the drawings. The upper ratchet locking collar 6542 of the ratchet locking assembly 6540 is permanently attached (via welding) to proximal ends 6758 of the vertical holding stanchion member 6756 of housing member 6752, as depicted in FIGS. 35 and 36 of the drawings. The proximal end 6758 of the vertical holding stanchion member includes an end cap member 6550 having a centrally located openings 6554 therethrough, as shown in FIGS. 35 and 36 of the drawings. As shown in FIG. 35, the adjustment bolt 6562 is received through aligned openings 6554 and 6812 in order to engage and lock the upper interlocking ratchet teeth 6548 with the lower interlocking ratchet teeth 6570 (see FIG. 34) of the ratchet locking assembly 6540.

In all other respects, the ratchet locking assembly 6540 and the modified anchoring post 6062M of fishing rod holder assembly 6000 is exactly the same as the ratchet locking assembly 5540 and anchoring post 5062 of fishing rod holder assembly 5000 of the sixth embodiment except for the elimination of the flat crossbar member 5070F from the seventh embodiment which allows for use of the single slightly modified multiple angle fishing rod holder member 6750 to hold only one (1) fishing pole 12 in a particular angle between 30° to 90° at user convenience.

The fishing rod holder assembly 7000 and its component parts of the first alternate configuration of the seventh alternate embodiment is represented in detail by FIG. 37 of the patent drawings. Elements illustrated in FIG. 34, which correspond to the elements described above with reference to FIGS. 34 to 36, have been designated by corresponding reference members increased by one thousand. The first alternate configuration 7000 of the seventh alternate embodiment is similarly constructed and operates in the same manner as the seventh alternate embodiment 6000, unless it is otherwise stated. All aspects of the first alternate configuration of the seventh alternate embodiment of fishing rod holder assembly 7000 having the multiple angle fishing rod holder member 7750 are exactly the same as the fishing rod holder assembly 6000 having the multiple angle fishing rod holder member 6750 of the seventh alternate embodiment except for a modified and angled anchoring post 7062A, as shown in FIG. 37. The angled anchoring post 7062A is integrally attached to the lower ratchet locking collar 7564 of the ratchet locking assembly 7540 at the distal end 7066 of the angled anchoring post 7062A, as depicted in FIG. 37. The angled anchoring post 7062A is skewed from an X-axis position X having an angle epsilon (ε) in the range of 30° to 90° from the X-axis position X. In all other respects, the ratchet locking assembly 7540 and the angled anchoring post 7062A of the fishing rod holder assembly 7000 is exactly the same as the ratchet locking assembly 6540 and the modified anchoring post 6062M of the seventh alternate embodiment except for skewed orientation of the angled anchoring post 7062A being a 45° angle from the X-axis position X, as shown in FIG. 37, in which the angled anchoring post 7062A is received within the flush mounted rod holder 7090 having an angled tubular body member 7098A.

The fishing rod holder assembly 8000 and its component parts of the second alternate configuration of the seventh alternate embodiment is represented in detail by FIG. 38 of the patent drawings. Elements illustrated in FIG. 38, which correspond to the elements described above with reference to FIG. 34, have been designated by corresponding reference numbers increased by two thousand. The second alternate configuration 8000 of the seventh alternate embodiment is similarly constructed and operates in the same manner as the seventh alternate embodiment 6000, unless it is otherwise stated. All aspects of the second alternate configuration of the seventh alternate embodiment of fishing rod holder assembly 8000 having the ratchet locking assembly 8540 and the modified anchoring post 8062M are exactly the same as the fishing rod holder assembly 6000 having the ratchet locking assembly 6540 and the modified anchoring post 6062M of the seventh alternate embodiment except an alternately designed multiple angle fishing rod holder member 8750D. The multiple angle fishing rod holder member 8750D includes a housing member 8752 being substantially L-shaped in configuration. The housing member 8752 includes an upper compartment section 8754 being integrally connected to a vertical holding stanchion member 8756 having a proximal end 8758, as shown in FIG. 38. The upper compartment includes a plurality of cylindrically shaped interior holding compartments 8760C, 8762C, 8764C and 8766C for the angled positioning of a fishing rod handle 12h of fishing rod 12 therein. Each of the cylindrically-shaped interior holding compartments 8760C, 8762C, 8764C and 8766C have corresponding angled position alignments of 90°, 60°, 45° and 30°, (P₁, P₂, P₃ and P₄) respectively, as shown in FIG. 38 of the drawings. In all other respects, the alternately designed multiple angle fishing rod holder member 8750D of fishing rod holder assembly 8000 is exactly the same as the multiple angle fishing rod holder member 6750 except that each of the interior holding compartments 8760C, 8762C, 8764C and 8766C are cylindrically shaped (see FIG. 38).

### OPERATION OF THE PRESENT INVENTION

In operation, the fishing rod holder assemblies 10, 200, 400, 600, 800, 1000 and 1200 of the preferred embodiment and their alternate configurations, and the second alternate embodiment and its configuration, as shown in FIGS. 1, 2, 6, 7, 8, 9, 11 and 14 of the patent drawings, operate in a similar manner. The user initially secures the fishing rod holders 20, 220, 420, 620, 820, 1020 and 1220 to each of the vertical holding posts 76, 78, 397, 399, 526, 628, 676, 678, 738, 876, 938, 944, 1120, 1122, 1320 and 1322 of the fishing rod holder support stanchion members 60, 260, 460, 660, 860, 1060 and 1260, accordingly, such that the clamping openings 58, 258, 458, 658, 858, 1058 and 1258 of the adjustable holding clamps 44, 244, 444, 644, 844, 1044 and 1244 are received on the outer wall surface 84, 284, 484, 684, 884, 1084 and 1284 of each of the vertical holding posts 76, 78, 397, 399, 526, 628, 676, 678, 738, 876, 938, 944, 1120, 1122, 1320 and 1322, respectively. The user then adjusts each of the adjustable holding clamps 44, 244, 444, 644, 844, 1044 and 1244 to a centrally placed position 86, 286, 486, 686, 886, 1086 and 1286 along the vertical Y axis of each of the vertical holding posts 76, 78, 397, 399, 526, 628, 676, 678, 738, 876, 938, 944, 1120, 1122, 1320 and 1322 for the convenience and use of the fishermen. The next step has the user inserting the proximal end 64, 264, 464, 664, 864, 1064 and 1264 of the anchoring posts 62, 262, 462, 662, 862, 1062 and 1262 within the sleeve openings 108, 308, 508, 708, 908, 1108 and 1308 of sleeves 106, 306, 506, 706, 906, 1106 and 1306 of the flush mounted rod holders 90, 290, 490, 690, 890, 1090 and 1290, respectively, such that the locking notched ends 68, 268, 468, 668, 868, 1068 and 1268 of the anchoring posts 62, 262, 462, 662, 862, 1062, and 1262 engage the safety gimbal pins 110, 310, 510, 710, 910, 1110 and 1310 of the flush mounted rod holders 90, 290, 490, 690, 890, 1090 and 1290, respectively. The final step has the fisherman inserting one or more fishing rod handle(s) 12h of the fishing rod(s) 12 within the fishing rod openings 28, 228, 428, 628, 828, 1028 and 1228 of the fishing rod holders 20, 220, 420, 620, 820, 1020 and 1220, respectively, such that the handle locking notched 12n of the gimbaled butt end 12g of the fishing rod handle 12h engage the rod holding pin 34, 234, 434, 634, 834, 1034 and 1234 of each of the fishing rod holders 20, 220, 420, 620, 820, 1020 and 1220, respectively, in order to firmly secure and hold the fishing rod 12 within the aforementioned fishing rod holders. If fishing boat 14 is not moving or in motion the user can reverse the last two (2) steps, whereby the user inserts the anchoring post 62, 262, 462, 662, 862, 1062 and 1262 of the fishing rod holder support stanchion member 60, 260, 460, 660, 860, 1060 and 1260 into the flush mounted rod holder 90, 290, 490, 690, 890, 1090 and 1290 (clamp-type mounted rod holder) initially, where then the user attaches the adjustable holding clamp 44, 244, 444, 644, 844, 1044 and 1244 to the vertical holding posts 76, 78, 397, 399, 526, 628, 676, 678, 738, 876, 938, 944, 1120, 1122, 1320 and 1322 of each support stanchion member 60, 260, 460, 660, 860, 1060 and 1260, respectively, as the second step in the operation of the present invention.

Additionally, as shown in FIGS. 11 and 14, the holding post member 1112 and the L-shaped holding post members 1372 and 1374 of the support stanchion members 1060 and 1260 are rotatable in either a clockwise or counterclockwise direction, C₃, C₅, C₄ or C₆. Further, each of the L-shaped holding post members 1472 and 1474 can be independently rotated in opposite directions in either a clockwise or counterclockwise rotation C₅ or C₆ in order to further maneuver and orient the mounted fishing rod holders 1020 and 1220 to a predetermined angled position of the user's choosing. Alternatively, as shown in FIG. 14, the proximal end 1264 of the anchoring post 1262 of the rotatable fishing rod holder support stanchion member 1260 is received within the fishing rod opening 1228 of fishing rod holder 1220, such that the adjustable holding clamp 1244 is connected to a vertical rail 18 of the fishing boat 14. It is understood that the fishing rod holder support stanchion members 60, 260, 460, 660, 860, 1060 and 1260 can be received in either a flush mounted rod holder on the gunwale 16 of the fishing boat 14 or within a clamp-type fishing rod holder detachably mounted to a vertical or horizontal rail 18 on the bridge section of the fishing boat 14.

The fishing rod holder assembly 2000 of the third alternate embodiment of the present invention, as shown in FIGS. 15 and 16 of the patent drawings, operates in the following manner. The user simply puts one or more fishing rod handle(s) 12h of fishing rods 12 within the fishing rod openings 2028 of the fishing rod holder 2020, accordingly, such that the gimbaled butt end 12g having the handle locking notch 12n is received and engaged by the rod holding pin 2034 located at the proximal end 2030 of the fishing rod holder 2020, respectively, in order to firmly secure and hold the fishing rod(s) 12 within the aforementioned fishing rod holder 2020. It should be understood in this third alternate embodiment 2000 that the fishing rod holders 2020 are permanently attached to each vertical holding post 2076 and 2078 in a predetermined angle and position during manufacture.

The fishing rod holder assembly 3000 of the fourth alternate embodiment of the present invention, as shown in FIGS. 17 through 20 of the patent drawings, operates in the following manner. The first step has the user loosening the set screws 3338 from the spaced-apart set screw openings 3374 of the lower movable sleeve collar 3370 of the retaining collar assembly 3330 in order to move the lower movable sleeve collar 3370 to a predetermined, centrally placed position 3086 along the vertical axis on each of the vertical holding posts 3076 and 3078, respectively, as depicted in FIGS. 17, 19 and 20 of the drawings, and then retightens the set screws 3338 within set screw opening 3374 in order to fix and hold the lower movable sleeve collar 3370 to each of the vertical holding posts 3076 and 3078. Now the user loosens the set screws 3338 from each of the set screw openings 3336 and 3358 of the upper and center movable sleeve collars 3332 and 3354, respectively, in order to move the center movable sleeve collar 3354 along the vertical axis on each of the vertical holding posts 3076 and 3078. The operator now further adjusts the center movable sleeve collar 3354 where then the operator rotatably moves the center movable sleeve collar 3354 in a horizontal clockwise or counterclockwise movement R₁ or R₂ in order to further set each of the fishing rod holders 3020 in a preset orientation at the convenience of the user. Next, the user engages the lower interlocking square-shaped ratchet teeth 3368 of the center movable sleeve collar 3354 with that of the upper interlocking square-shaped ratchet teeth 3378 of the lower movable sleeve collar 3370 in order to set the center and lower movable sleeve collars 3354 and 3370 together, as depicted in FIGS. 19 and 20. The user now sets and locks the set screws 3338 within set screw openings 3358 in order to lock and engage the interlocking ratchet teeth 3368 and 3378 together, as depicted in FIGS. 17 and 19 of the patent drawings. The upper movable sleeve collar 3332 of the retaining collar assembly 3330 is now movable between an upward or downward movement and extends from position P_{A} (the rod holder member 3022 of fishing rod holder 3020 has an aligned angled position A_{A} of 90° relative to the vertical holding post 3076 or 3078) via the movable pin joint flexing arm 3346 to position P_{B} (the rod holder member 3022 of fishing rod holder 3020 has an aligned angled position A_{B} of 30° relative to the vertical holding post 3076 and 3078). The user now sets a desired position between the angled positions A_{A} to A_{B} of fishing rod holder 3020 by tightening the set screws 3338 within the set screw openings 3336 of the upper movable sleeve collar 3332, such that the upper movable sleeve collar 3332 is now in a locked position between P_{A} and P_{B}, as depicted in FIGS. 19 and 20 of the patent drawings. In the last step, the user simply puts one or more fishing rod handle(s) 12h of fishing rod(s) 12 within the fishing rod openings 3028 of the fishing rod holders 3020, accordingly, and that the gimbaled butt end(s) 12g having the handle locking notch(es) 12n are received and engaged by the rod holding pins 3034 located at the proximal ends 3030 of the fishing rod holders 3020, respectively, in order to firmly secure and hold the fishing rod(s) 12 within the aforementioned fishing rod holders 3020, as shown in FIG. 17 of the drawings.

The fishing rod holder assembly 4000 of the fifth alternate embodiment of the present invention, as shown in FIGS. 21 through 24 of the patent drawings, operates in the following manner. The user initially inserts the proximal end 4064 of the anchoring post 4062 of the fishing rod holder support stanchion member 4060 within the sleeve openings 4108 of the sleeve 4106 of the flush mounted rod holder 4090, such that the locking notched end 4068 of the anchoring post 4062 engages the safety gimbal pin 4110 of the flush mounted rod holder 4090, as depicted in FIG. 21 of the drawings. In the next step, the user loosens each of the adjustment bolts 4562 from the openings 4554 and 4556 of locking nuts 4558 and 4560 via a bolt removing device 4002 from the flat bar bolt openings 4572 and 4574 on each of the opposing ends 4072 and 4074, respectively, of the flat horizontal crossbar member 4070F, as depicted in FIGS. 23 and 24 of the patent drawings. The user now disengages each of the interlocking ratchet teeth 4548 of the movable upper ratchet locking collars 4542 from each of the interlocking ratchet teeth 4570 of the permanently attached lower ratchet locking collars 4564 of ratchet locking assemblies 4540, as shown in FIG. 23, in order to rotate each of the fishing rod holders 4020 in a clockwise or counterclockwise movement R₁ or R₂ in order to set each of the fishing rod holders 4020 in a specific orientation at the user's discretion. Next, the user engages each of the interlocking ratchet teeth 4548 of the movable upper ratchet locking collars 4542 with each of the interlocking ratchet teeth 4570 of the lower ratchet locking collars 4564 of the ratchet locking assemblies 4540, as shown in FIG. 24, where then the user tightens each of the adjustment bolts 4562 within the openings 4554 and 4556 of locking nuts 4558 and 4560 via the bolt tightening device 4002 from the flat bar bolt openings 4572 and 4574 located on each of the opposing ends 4072 and 4074, respectively, of the flat horizontal crossbar member 4070F (see FIGS. 21 and 24). This aforementioned step sets and locks each of the ratchet locking assemblies 4540, as shown in FIG. 21, in the desired positions for each of the fishing rod holders 4020, in the last step, the user simply puts one or more fishing rod handle(s) 12h of fishing rod(s) 12 within the fishing rod openings 4028 of the fishing rod holders 4020, accordingly, such that the gimbaled butt ends 12g having the handle locking notches 12n are received and engaged by the rod holding pins 4034 of the fishing rod holders 4020, respectively, in order to firmly secure and hold each of the fishing rod(s) 12 within the aforementioned fishing rod holders 4020, as shown in FIG. 21 of the drawings.

The multiple angle fishing rod holder assembly 5000 of the sixth alternate embodiment of the present invention, as shown in FIGS. 25 through 33 of the patent drawings, operates in the following manner. The user initially inserts the proximal end 5064 of the anchoring post 5062 of the fishing rod holder support stanchion member 5060 within the sleeve opening 5108 of sleeve 5106 of the flush mounted rod holder 5090, such that the locking notched end 5068 of the anchoring post 5062 engages the safety gimbal pin 5110 of the flush mounted rod holder 5090, as depicted in FIG. 25 of the drawings. In the next step, the user loosens each of the adjustment bolts 5562 from the openings 5554 and 5556 of locking nuts 5558 and 5560 via a bolt removing device 5002 from the flat-bar bolt openings 5572 and 5574 on each of the opposing ends 5072 and 5074, respectively, of the flat horizontal crossbar member 5070F, as depicted in FIGS. 25 to 27 of the patent drawings. The user now disengages each of the interlocking ratchet teeth 5548 of the movable upper ratchet locking collars 5542 from each of the interlocking ratchet teeth 5570 of the permanently attached lower ratchet locking collars 5564 of ratchet locking assemblies 5540, as shown in FIG. 26, in order to rotate each of the multiple angle fishing rod holder members 5750 in a clockwise or counterclockwise movement R₁ or R₂ in order to set each of the multiple angle fishing rod holder members 5750 in a specific orientation at the user's discretion. Next, the user engages each of the interlocking ratchet teeth 5548 of the movable upper ratchet locking collars 5542 with each of the interlocking ratchet teeth 5570 of the lower ratchet locking assemblies 5540, as shown in FIGS. 25 and 26 of the drawings, where then the user tightens each of the adjustment bolts 5562 within the openings 5554 and 5556 of locking nuts 5558 and 5560 via the bolt tightening device 5002 from the flat bar bolt openings 5572 and 5574 located on each of the opposing ends 5072 and 5074, respectively, of the flat horizontal crossbar member 5070F (see FIGS. 25 and 27). This aforementioned step sets and locks each of the ratchet locking assemblies 5540, as shown in FIG. 25, in the desired positions for each of the multiple angle fishing rod holder members 5070. In the last step, the user simply inserts one or more fishing rod handle(s) 12h of fishing rod(s) 12 within one of the interior holding compartments 5760, 5762, 5764 or 5766, accordingly, as shown in FIGS. 30, 31, 32 or 33 of the patent drawings. At the user's discretion, the fishing rod 12 placement can be received within an angled position of 90° (P₁), 60° (P₂), 45° (P₃) or 30° (P₄) of one of the interior compartments 5760, 5762, 5764 5766, respectively, such that the gimbaled butt ends 12g having the handle locking notches 12n are received and engaged by the removable holding and locking pins 5782 located at the proximal ends 5758 of the vertical holding stanchion members 5756 of the multiple angle fishing rod holder members 5750, accordingly, in order to firmly secure and hold each of the fishing rod(s) 12 within the aforementioned multiple angle fishing rod holder members 5750, as shown in FIG. 25 of the patent drawings.

The multiple angle fishing rod holder assemblies 6000, 7000 and 8000 of the seventh alternate embodiment and their alternate design configurations, as shown in FIGS. 34 through 38 of the patent drawings, operate in a similar manner. The user initially inserts the proximal ends 6064, 7064 and 8064 of the anchoring posts 6062M, 7062 and 8062 within the sleeve openings 6108, 7108 and 8108 of sleeve 6106, 7106 and 8106 of the flush mounted rod holder 6090, 7090 and 8090, respectively, such that the locking notched ends 6058, 7058 and 8058 of the anchoring posts 6062M, 7062A and 8062M engages the safety gimbal pins 6110, 7110 and 8110 of the flush mounted rod holders 6090, 7090 and 8090, respectively, as depicted in FIGS. 34, 35, 37 and 38 of the drawings. In the next step, the user loosens the adjustment bolt 6562, 7562 and 8562 from the centrally located openings 6554, 7554 and 8554 at the end cap member 6550, 7550 and 8550 of the vertical holding stanchion member 6756, 7756 and 8756 and from the centrally located openings 6812, 7812 and 8812 of locking nut 6814, 7814 and 8814 at the end cap member 6810, 7810 and 8810 on the distal end 6066, 7066 and 8066 of the modified anchoring post 6062M, 7062A and 8062M, respectively, such that the user accesses the adjustment bolt 6562, 7562 and 8562 from the first interior holding compartment 6760, 7760 and 8760 using the bolt removing device 6002, 7002 and 8002, as shown in FIGS. 35 and 36 of the drawings. The user now disengages the interlocking ratchet teeth 6548, 7548 and 8548 of the movable upper ratchet teeth 6570, 7570 and 8570 of the permanently attached lower ratchet locking collar 6564, 7564 and 8564 of ratchet locking assembly 6540, 7540 and 8540, as shown in FIGS. 35, 36, 37 and 38 of the patent drawings, in order to rotate the multiple angle fishing rod holder member 6750, 7750 and 8750D in a clockwise or counterclockwise movement R₁ or R₂ in which to set the multiple angle fishing rod holder member 6750, 7750 and 8750D in a specific orientation at the user's discretion. Next, the user engages the interlocking ratchet teeth 6548, 7548 and 8548 of the movable upper ratchet locking collar 6542, 7542 and 8542 with the interlocking ratchet teeth 6570, 7570 and 8570 of the permanently mounted lower ratchet locking collar 6564, 7564 and 8564 of the ratchet locking assembly 6540, 7540 and 8540, as shown in FIGS. 34 to 38 of the drawings, where then the user tightens the adjustment bolt 6562, 7562 and 8562 within aligned openings 6554 and 6812, 7554 and 7812, and 8554 and 8812 via the bolt tightening device 6002, 7002 and 8002, as shown in FIGS. 34, 37 and 38 of the drawings. This aforementioned step sets and locks the ratchet locking assembly 6540, 7540 and 8540, as depicted in FIGS. 34, 37 and 38, in the desired position as selected by the user. In the last step, the user simply inserts one fishing rod handle 12h of fishing rod 12 within one of the interior holding compartments 6760 to 6766, 7760 to 7766 and 8760C to 8766C, accordingly, as shown in FIG. 38 of the drawings. At the user's discretion, the fishing rod 12 placement can be received within an angled position 90° (P₁), 60° (P₂), 45° (P₃) or 30° (P₄) of one of the interior holding compartments 6760 to 6766, 7760 to 7766 and 8760C to 8766C, respectively, such that the gimbaled butt end 12g having the handle locking notch 12n thereon is received and engaged by the removable holding and locking pin 6782, 7782 and 8782 located at the proximal end 6758, 7758 and 8758 of the vertical holding stanchion member 6756, 7756 and 8756 of the multiple angle fishing rod holder member 6750, 7750 and 8750D, accordingly, in order to firmly secure and hold the fishing rod 12 within the aforementioned multiple angle fishing rod holder member 6750, 7750 and 8750D, as shown in FIGS. 34, 37 and 38 of the patent drawings.

### ADVANTAGES OF THE PRESENT INVENTION

Accordingly, an advantage of the present invention is that it provides a fishing rod holder assembly for holding multiple fishing rods that allows power boats, such as pleasure cruisers, small fishing boats, having limited gunwale space for fishing or trolling to fish, troll or hold two or more fishing rods being received within using two or more mountable fishing rod holders.

Another advantage of the present invention is that it provides a fishing rod holder assembly that includes a fishing rod holder support stanchion member, a plurality of fishing rod holders, and a flush mounted rod holder for use on pleasure fishing boats or small commercial fishing boats.

Another advantage of the present invention is that it provides for a fishing rod holder support stanchion member that includes two or more vertical holding posts being integrally attached to a crossbar member and the crossbar member integrally attached to the anchoring post.

Another advantage of the present invention is that it provides for a fishing rod holder assembly that allows the ability to fish/troll/hold more fishing poles than would be possible using the existing rod holders mounted on a boat (gunwale flush mount or clamp-on type).

Another advantage of the present invention is that it provides a fishing rod holder support stanchion member for holding a plurality of fishing rod holders in combination with a flush mounted rod holder within a gunwale of a boat.

Another advantage of the present invention is that it provides the ability to fish/troll/hold a plurality of fishing rods by attaching commercially available vertical mounted fishing rod holders to the rod holder support stanchion member of the fishing rod holder assembly which is anchored to a flush mounted rod holder in the gunwale of a boat.

Another advantage of the present invention is that it provides a fishing rod holder support stanchion member having two or more vertical holding posts that show a goalpost configuration, a Y-shaped configuration, a U-shaped configuration, and a skewed angled configuration.

Another advantage of the present invention is that it provides a fishing rod holder support stanchion member that includes a plurality of vertical holding posts integrally attached to a telescoping crossbar member.

Another advantage of the present invention is that it provides a fishing rod holder support stanchion member that allows a longer extension of one side of the crossbar member to extend outside of the gunwale of the boat in order to maximize the separation of the outside fishing rod from the inside fishing rod.

Another advantage of the present invention is that it provides a fishing rod holder assembly that has integrally attached fishing rod holders to each of the vertical holding posts of fish rod holders support stanchion member providing a “ready to use” assembly.

Another object of the present invention is to provide a fishing rod holder support stanchion member having a crossbar member being rotatable relative to the anchoring post using an adjustable locking block member.

Another advantage of the present invention is that it provides a fishing rod holder assembly that incorporates a locking block for the crossbar member and anchoring post allowing unlimited angle adjustment of the vertical holding posts relative to the attached fishing rod holders.

Another advantage of the present invention is that it provides a fishing rod holder support stanchion member having one or more vertical posts that are independently rotatable relative to each other using the adjustable locking block member.

Another advantage of the present invention is that it provides a single fishing rod holder assembly that can be adapted to fit any of the commercially available 15°, 30° or 90° flush mount rod holders.

Another advantage of the present invention is that it provides a fishing rod holder assembly having a pair of independently L-shaped rotatable holder support stanchion members that move relative to each other using an adjustable locking block.

Another advantage of the present invention is that it provides for a fishing rod holder assembly in which the joint between the crossbar member and vertical holding post can be rotated 360° relative to a stationary crossbar member.

Another advantage of the present invention is that it provides a fishing rod holder assembly that has permanently mounted, fully adjustable fishing rod holders that can be rotated 360° around, and up and down on the vertical holding posts of the fishing rod holder support stanchion member.

Another advantage of the present invention is that it provides a fishing rod holder support stanchion member having vertical posts with each having a removably attached fishing rod holder that is adjustable to a predetermined angle.

Another advantage of the present invention is that it provides a fishing rod holder support stanchion member having multiple interior holding compartments for forming a multiple angle fishing rod holder member for the angled positioning of a fishing rod therein.

Another advantage of the present invention is that it provides a fishing rod holder support stanchion member having vertical posts that are angled and movable in a 120° arc.

Another advantage of the present invention is that it provides a fishing rod holder support stanchion member being constructed to form a single integral unit by means of welding an/or tubular bending.

Another advantage of the present invention is that it provides a fishing rod holder support stanchion member that is made of lightweight and easy to clean metals such as aluminum, stainless steel, titanium and other steel alloys.

Another advantage of the present invention is that it provides a fishing rod holder assembly that is easy to assemble having a minimum amount of moving parts, easy to use and maintain for any type of boat.

A further advantage of the present invention is that it provides a fishing rod holder assembly that can be mass-produced in an automated and economical manner and is readily affordable by the user.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

1-127. (canceled)

128. A fishing rod holder assembly for holding one or more fishing rods, comprising:
a) a rod holder flush mounted within a gunwale of a boat;
b) two or more fishing rod holders extending upwardly each for holding a separate fishing rod therein;
c) a U-shaped fishing rod holder support stanchion member including an anchoring post and a horizontal crossbar member connected thereto in an offset manner;
d) said horizontal crossbar member having a first opposing end and a second opposing end;
e) said first opposing end having a first upwardly extending holding post connected thereto and said second opposing end having a second upwardly extending holding post connected thereto for forming a U-shaped configuration thereof;
f) said anchoring post being mounted within said flush mounted rod holder; and
g) a first attachment element having at least one end shaped at an angle relative to the vertical axis for attaching one of said fishing rod holders to said first upwardly extending holding post of said fishing rod holder support stanchion member and a second attachment element having at least one end shaped at an angle relative to the vertical axis for attaching a second one of said fishing rod holders to said second upwardly extending holding post of said fishing rod holder support stanchion member for forming a fishing rod holder assembly thereof.

129. A fishing rod holder assembly in accordance with claim 128, wherein said anchoring post is connected to said horizontal crossbar member in a perpendicular relationship to said horizontal crossbar member.

130. A fishing rod holder assembly in accordance with claim 128, wherein said anchoring post having a proximal end and a distal end, said proximal end including a locking notched end.

131. A fishing rod holder assembly in accordance with claim 128, wherein said fishing rod holder assembly is integrally connected to form a unitary constructed unit.

132. A fishing rod holder assembly in accordance with claim 128, wherein said fishing rod holder support stanchion member is made from materials being rust resistant that are selected from the group consisting of durable plastics, steel, stainless steel, aluminum and titanium.

133. A fishing rod holder assembly in accordance with claim 131, wherein said fishing rod holder support stanchion member is made of tubular construction to form said unitary constructed unit.

134. A fishing rod holder assembly in accordance with claim 133, wherein said tubular construction of said fishing rod holder support stanchion member is formed by welding to form said unitary constructed unit.

135. A fishing rod holder assembly in accordance with claim 133, wherein said tubular construction of said fishing rod holder support stanchion member is formed by tubular bending to form said unitary construction unit.

136-232. (canceled)

233. A fishing rod holder assembly in accordance with claim 128, wherein said first attachment element includes a first circular clamping member for receiving therein said first upwardly extending holding post, and said second attachment element includes a second circular clamping member for receiving therein said second upwardly extending holding post.

234. A fishing rod holder assembly in accordance with claim 128, wherein each of said first and second upwardly extending holding posts is disposed at an angle relative to the vertical axis.

235. (canceled)

236. A fishing rod holder assembly in accordance with claim 128, wherein each of said first and second upwardly extending holding posts are perpendicular to said horizontal crossbar member.

237. A fishing rod holder assembly in accordance with claim 128, wherein at least one of said first and second upwardly extending holding posts are at an angle to a vertical Y-axis relative to said horizontal crossbar member.

238. (canceled)

239. A fishing rod holder assembly in accordance with claim 128, wherein said horizontal crossbar member further includes a third upwardly extending holding post connected to said horizontal crossbar member.

240. A fishing rod holder assembly in accordance with claim 239, wherein said anchoring post is connected to said horizontal crossbar member between said third upwardly extending holding post and one of said first and second upwardly extending holding posts for forming a trident-shaped configuration.

241. A fishing rod holder assembly in accordance with claim 128, wherein said horizontal crossbar member includes a telescoping receiving end for receiving an L-shaped telescoping member therein for forming an adjustable telescoping trident-shaped configuration.

242. A fishing rod holder assembly in accordance with claim 241, wherein said L-shaped telescoping member includes a third vertical holding post and a telescoping horizontal crossbar member having an opening therein.

243. A fishing rod holder assembly in accordance with claim 242, wherein said telescoping horizontal crossbar member includes a turn-stop opening for receiving a turn-stop member therethrough.

244. A fishing rod holder assembly in accordance with claim 243, wherein said telescopic receiving end includes a plurality of turn-stop crossbar openings for receiving said turn-stop member therethrough, such that said telescoping receiving end is slidably received within said opening of said telescoping horizontal crossbar member of said L-shaped telescoping member in order to adjust an appropriate length of said telescoping horizontal crossbar member when said turn-stop member is tightened within said turn-stop opening and one of said turn-stop crossbar openings, respectively.

245. A fishing rod holder assembly in accordance with claim 128, wherein said first upwardly extending holding post rotates relative to said second upwardly extending holding post.

246. A fishing rod holder support stanchion member for holding multiple fishing rod holders in combination with a boat mounted rod holder, comprising:
a) a U-shaped fishing rod holder support stanchion member including an anchoring post and a horizontal crossbar member connected thereto in an offset manner;
b) said horizontal crossbar member having a first opposing end and a second opposing end; and
c) said first opposing end having a first upwardly extending holding post connected thereto and said second opposing end having a second upwardly extending holding post connected thereto for forming a U-shaped configuration thereof; and
d) two fishing rod holders extending upwardly each for holding a separate fishing rod therein; each of said fishing rod holders being connected to one of said upwardly extending holding posts.

247. A fishing rod holder support stanchion member in accordance with claim 246, wherein said anchoring post is connected to said horizontal crossbar member in a perpendicular relationship to said horizontal crossbar member.

248. A fishing rod holder support stanchion member in accordance with claim 246, wherein each of said first and second upwardly extending holding posts are at an angle to a vertical Y-axis relative to said horizontal crossbar member.

249. (canceled)

250. A fishing rod holder support stanchion member in accordance with claim 246, wherein at least one of said first and second upwardly extending holding posts are at an angle to a vertical Y-axis relative to said horizontal crossbar member.

251. (canceled)

252. A fishing rod holder support stanchion member in accordance with claim 246, wherein each of said first and second upwardly extending holding posts are perpendicular to said horizontal crossbar member.

253. A fishing rod holder support stanchion member in accordance with claim 246, wherein said anchoring post has a proximal end and a distal end, said proximal end including a locking notched end.

254. A fishing rod holder support stanchion member in accordance with claim 246, wherein said horizontal crossbar member further includes a third upwardly extending holding post connected to said horizontal crossbar member.

255. A fishing rod holder support stanchion member in accordance with claim 254, wherein said anchoring post is connected to said horizontal crossbar member between said third upwardly extendng holding post and one of said first and second vertical holding posts for forming a trident-shaped configuration.

256. A fishing rod holder support stanchion member in accordance with claim 246, wherein said horizontal crossbar member includes a telescoping receiving end for receiving an L-shaped telescoping member therein for forming an adjustable telescoping trident-shaped configuration.

257. A fishing rod holder support stanchion member in accordance with claim 256, wherein said L-shaped telescoping member includes a third vertical holding post and a telescoping horizontal crossbar member having an opening therein.

258. A fishing rod holder support stanchion member in accordance with claim 257, wherein said telescoping horizontal crossbar member includes a turn-stop opening for receiving a turn-stop member therethrough.

259. A fishing rod holder support stanchion member in accordance with claim 258, wherein said telescopic receiving end includes a plurality of turn-stop crossbar openings for receiving said turn-stop member therethrough, such that said telescoping receiving end is slidably received within said opening of said telescoping horizontal crossbar member of said L-shaped telescoping member in order to adjust an appropriate length of said telescoping horizontal crossbar member when said turn-stop member is tightened within an adjacent turn-stop opening and one of said turn-stop crossbar openings, respectively.

260. A fishing rod holder support stanchion member in accordance with claim 246, wherein said first upwardly extending holding post rotates relative to said second upwardly extending holding post.

261. A fishing rod holder support stanchion member in accordance with claim 246, wherein said fishing rod holder support stanchion member is integrally connected to form a unitary constructed unit.

262. A fishing rod holder support stanchion member in accordance with claim 246, wherein said fishing rod holder support stanchion member is made from materials being rust resistant that are selected from the group consisting of durable plastics, steel, stainless steel, aluminum and titanium.

263. A fishing rod holder support stanchion member in accordance with claim 261, wherein said fishing rod holder support stanchion member is made of tubular construction to form said unitary constructed unit.

264. A fishing rod holder support stanchion member in accordance with claim 263, wherein said tubular construction of said fishing rod holder support stachion member is formed by welding to form said unitary constructed unit.

265. A fishing rod holder support stanchion member in accordance with claim 263, wherein said tubular construction of said fishing rod holder support stanchion member is formed by tubular bending to form said unitary constructed unit.

266. A fishing rod holder support stanchion member in accordance with claim 246, wherein said horizontal crossbar member includes three or more upwardly extending holding posts connected thereto.

267. A fishing rod holder support stanchion member in accordance with claim 246, wherein said anchoring post is detachably mounted within a clamp-type mounted rod holder on a rail of a boat or a flush-mounted rod holder on a gunwale of a boat.

268. A fishing rod holder support stanchion member in accordance with claim 254, further including a third fishing rod holder extending upwardly being connected to said third upwardly extending holding post.
